(19) United States
(12) Patent Application Publication
(10) Pub. No.: US 2026/0304412 A1
(43) Pub. Date: Oct. 1, 2026

(54) METHOD AND APPARATUS FOR SENSING A BEAM SELECTION IN A WIRELESS COMMUNICATION SYSTEM

(71) Applicant: Samsung Electronics Co., Ltd., Suwon-si, Gyeonggi-do (KR)

(72) Inventors: Zhongfeng ZHANG, Beijing (CN); Di SU, Beijing (CN); Chen QIAN, Beijing (CN); Peng LIN, Beijing (CN); Nan QU, Beijing (CN); Qi LI, Beijing (CN)

(21) Appl. No.: 19/473,569

(22) PCT Filed: Jan. 4, 2024
(86) PCT No.: PCT/KR2024/000156

§ 371 Date: Oct. 8, 2025

(30) Foreign Application Priority Data
May 31, 2023 (CN) 202310636457.0

(51) Int. Cl. H04W 72/044; H04W 72/51; H04W 72/542

(52) U.S. Cl. CPC H04W 72/046; H04W 72/51; H04W 72/542

(57) ABSTRACT

The present disclosure relates to a 5G communication system or a 6G communication system for supporting higher data rates beyond a 4G communication system such as long term evolution (LTE). A method performed by a first user equipment (UE) in a wireless communication system, the method comprising transmitting, to a second UE, a request message for collaborative sensing, receiving, from the second UE, a response message including sensing measurements based on the request message, and transmitting, to the second UE, a sensing signal for a beam selection based on the sensing measurements, wherein the second UE is a UE which is identified as a UE with the collaborative sensing based on the request message.

### TECHNICAL FIELD

The present disclosure relates to communication sensing, and more specifically, to methods for terminal self-transmitting and self-receiving sensing and/or collaborative sensing between terminals, as well as terminal devices for performing the methods.

### BACKGROUND ART

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as κG communication systems and have the 1/10 radio latency thereof

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Solution to Problem

This disclosure relates to wireless communication networks, and more particularly to a terminal and a communication method thereof in a wireless communication system.

In accordance with an aspect of the disclosure, a method performed by a first node in a wireless communication system is provided, the method comprises: receiving configuration information including a sensing related first parameter; and transmitting a first signal for sensing based on sensing related information in the case of a first condition being met, wherein the sensing related information is obtained based on the first parameter or the first condition.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example wireless network according to embodiments of the present disclosure;

FIG. 2 illustrates an example base station according to the embodiments of the present disclosure;

FIG. 3 illustrates an example user equipment according to the embodiments of the present disclosure;

FIG. 4 illustrates a flowchart of a method for adaptively adjusting beam scanning parameters by a terminal based on the sensing information of targets in the environment according to the embodiments of the present disclosure;

FIG. 5 illustrates an example of beams of different shapes according to the embodiments of the present disclosure;

FIG. 6A illustrates an example of a beam scanning range according to the embodiments of the present disclosure;

FIG. 6B illustrates an example of adaptive beam selection and dynamic determination of beam scanning range based on echo signals in the environment according to the embodiments of the present disclosure;

FIG. 6C illustrates an example of changing the beam set according to the embodiments of the present disclosure;

FIG. 7 illustrates a flowchart of a method for adjusting beam scanning parameters through collaborative sensing between terminals according to the embodiments of the present disclosure;

FIG. 8 illustrates a flowchart of another method for adjusting beam scanning parameters through collaborative sensing between terminals according to the embodiments of the present disclosure;

FIG. 9 illustrates a flowchart of yet another method for adjusting beam scanning parameters through collaborative sensing between terminals according to the embodiments of the present disclosure;

FIG. 10 illustrates a block diagram of a base station according to the embodiments of the present disclosure; and

FIG. 11 illustrates a block diagram of a terminal according to the disclosed embodiment.

Throughout the drawings, it should be noted that like reference numbers are used to depict the same or similar elements, features, and structures.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

According to embodiments of the present disclosure, a method performed by a first node in a wireless communication system is provided, the method comprises: receiving configuration information including a sensing related first parameter; and transmitting a first signal for sensing based on sensing related information in the case of a first condition being met, wherein the sensing related information is obtained based on the first parameter or the first condition.

In some examples, the first parameter comprises at least one of the following: beam scanning mode, single or multiple beam scanning ranges, beam scanning period within each beam scanning range, beam scanning interval, beam type, angle of main lobe beam, power of main lobe beam, peak side lobe ratio, and beam set used within each beam scanning range.

In some examples, the beam scanning mode includes uniform scanning and/or non-uniform scanning.

In some examples, the sensing related information includes at least one of the following: distance of a first target relative to the first node; angle of a first target relative to the first node; velocity of a first target relative to the first node; and direction of movement of a first target relative to the first node.

In some examples, the first condition includes at least one of the following: the first node dynamically or semi-statically obtains configuration information including a sensing related second parameter; power of the time-domain channel estimation result based on the first signal is greater than or equal to a first threshold value; power of the Doppler domain channel estimation result based on the first signal is greater than or equal to a second threshold value; distance of a first target relative to the first node is less than or equal to a first threshold; angle of a first target relative to the first node is within an angle range; and position of a first target remains unchanged or an amount of position change is less than or equal to a second threshold within a first time range.

In some examples, the first threshold value, the second threshold value, the first threshold, the angle range, the first time range, and the second threshold are obtained by at least one of the following: being preset; obtained from other nodes; obtained from the physical downlink shared channel or physical downlink control channel; obtained from the physical sidelink shared channel or physical sidelink control channel; obtained from downlink control information or sidelink control information; and obtained from high-layer signaling.

In the technical solution provided in this disclosure, in the case of the first condition being met, the first node transmits a first signal for sensing based on sensing related information. Since the first node can adaptively adjust the sensing beam based on sensing related information to transmit the first signal, the problem of detection limitations caused by blind spot range in sensing can be solved.

According to embodiments of the present disclosure, a method performed by a first node in a wireless communication system is provided, the method comprises: transmitting a request message for requesting collaborative sensing to a second node in the case of a second condition being met; receiving a response message from the second node, the response message includes relevant information for collaborative sensing; and transmitting a second signal for sensing based on the relevant information for collaborative sensing.

In some examples, prior to transmitting the request message for requesting collaborative sensing to the second node, further comprising: transmitting a third signal for sensing to obtain sensing related information, wherein the sensing related information includes the sensing related information of the second node.

In some examples, the request message for requesting collaborative sensing includes at least one of sensing accuracy related parameters, sensing related resource occupation information of the first node, position related information of the first node, velocity related information of the first node, and a first range, wherein, the first range indicates a range related to the angle and/or distance that the first node requests the second node to sense collaboratively.

In some examples, the sensing accuracy parameters include at least one of the sensing accuracy related parameter for distance, sensing accuracy related parameter for velocity, and sensing accuracy related parameter for angle.

In some examples, the sensing related information of the second node includes at least one of the following: distance of the second node relative to the first node; angle of the second node relative to the first node; velocity of the second node relative to the first node; and direction of movement of the second node relative to the first node.

In some examples, the second condition includes at least one of the following: the first node receives an indication message, wherein the indication message includes information related to indicating to transmit the request message to the second node; power of the time-domain channel estimation result based on the third signal is greater than or equal to a third threshold value; power of the Doppler domain channel estimation result based on the third signal is greater than or equal to a fourth threshold value; distance of the second node relative to the first node is less than or equal to a third threshold; angle of the second node relative to the first node is within an angle range; position of the second node remains unchanged or an amount of position change is less than or equal to the fourth threshold within a second time range; the number of the second node sensed is greater than zero and less than or equal to a first number; and the number of second nodes sensed based on multiple different beam sets is greater than zero and less than or equal to a second number.

In some examples, transmitting the request message for requesting collaborative sensing to the second node, comprising: transmitting the request message to the second node through unicast, multicast, or broadcast.

In some examples, the relevant information for collaborative sensing includes at least one of the following: position related information of the second node, velocity related information of the second node, sensing related information of the second target sensed by the second node within the first range, position related information of the second target sensed by the second node within the first range, and sensing related resource occupation information of the second node.

In some examples, the sensing related information of the second target includes at least one of the following: distance of the second target relative to the second node; angle of the second target relative to the second node; velocity of the second target relative to the second node; and direction of movement of the second target relative to the second node.

In some examples, receiving the response message from the second node comprises: receiving the response message from any second node among the second nodes; and/or receiving the response message from at least one second node among the second nodes, wherein the relevant estimation value of the beam used by the at least one second node to transmit the response message is greater than or equal to a fifth threshold.

In some examples, transmitting a sensing related signal based on the relevant information for collaborative sensing, comprising: transmitting the sensing related signal based on the relevant information for collaborative sensing in the case of a third condition being met.

In some examples, the third condition includes at least one of the following: delay in receiving the response message is less than a first delay threshold; and the response message is valid.

In some examples, the delay in receiving the response message indicates the time elapsed from completing the transmission of the request message for requesting collaborative sensing to receiving the response message.

In some examples, when the distance of the second node relative to the first node is within a second range, the response message is valid, or when the distance of the second node relative to the first node is outside the second range, the response message is invalid.

According to embodiments of the present disclosure, a method performed by a second node in a wireless communication system is provided, the method comprises: receiving a request message for requesting collaborative sensing from a first node; transmitting a response message to the first node in the case of a fourth condition being met, the response message includes relevant information for collaborative sensing; wherein the relevant information for collaborative sensing is used by the first node to transmit a second signal for sensing.

In some examples, the request message for requesting collaborative sensing includes: at least one of sensing accuracy related parameters, sensing related resource occupation information of the first node, position related information of the first node, and a first range, wherein, the first range indicates the range related to the angle and/or distance that the first node requests collaborative sensing from the second node.

In some examples, the fourth condition includes at least one of the following: the sensing accuracy of the second node meets a fifth condition, wherein the fifth condition is related to the sensing accuracy related parameters; resources used by the second node for communication and/or sensing do not conflict with resources used by the first node for communication and/or sensing; the first node exists within the communication range and/or sensing range of the second node; the first range is within the sensing range of the second node; and the first range is within the sensing range of the second node, and the second node senses a second target within the first range.

In some examples, when at least one of the following conditions is met, it is determined that the second node senses the second target within the first range: the power of the time domain channel estimation result based on a fourth signal is greater than or equal to a fifth threshold value; and the power of the Doppler domain channel estimation result based on the fourth signal is greater than or equal to a sixth threshold value. Wherein, the fourth signal is a signal for sensing transmitted by the second node within the first range.

In the technical solution provided in this disclosure, transmitting a request message for requesting collaborative sensing to the second node in the case of the second condition being met; and receiving a response message containing relevant information for collaborative sensing from the second node, and further transmitting a second signal for sensing based on the relevant information for collaborative sensing. Therefore, the sensing beam can be adjusted based on the relevant information for collaborative sensing to transmit a second signal, and the problem of detection limitations caused by blind spot range in sensing can be solved.

According to embodiments of the present disclosure, a node device is also provided, which comprises: a transceiver; and a processor which is configured to perform one or more of the above methods.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

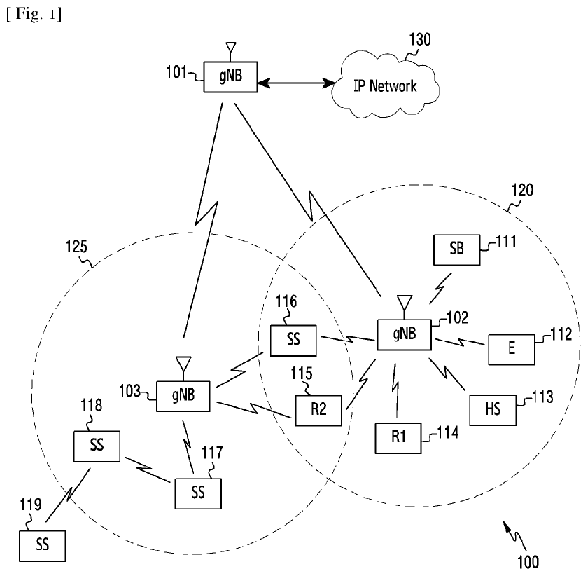

FIG. 1-FIG. 3 below describe various embodiments of the present disclosure implemented in wireless communications systems. The descriptions of FIG. 1-FIG. 3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a base station (gNB or gNodeB) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M), such as a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116, as well as subscriber stations (SS, for example, UEs) 117, 118 and 119. In some embodiments, one or more of the gNBs 101-103 may communicate with each other and with the UEs 111-116 using existing wireless communication techniques, and one or more of the UE 111-119 may communicate directly with each other (e.g., UEs 117-119) using other existing or proposed wireless communication techniques.

Depending on the network type, the term “base station” or “BS” can refer to any component (or collection of components) configured to provide wireless access to a network, such as transmit point (TP), transmit-receive point (TRP), an enhanced (or “evolved”) base station (eNodeB or eNB), a 5G base station (gNB), a macrocell, a femtocell, a wireless fidelity (WiFi) access point (AP), or other wirelessly enabled devices. Base stations may provide wireless access in accordance with one or more wireless communication protocols, e.g., 3GPP 5G New Radio (NR), Long Term Evolution (LTE), LTE Advanced (LTE-A), high speed packet access (HSPA), Wi-Fi 802.11a/b/g/n/ac, etc. For the sake of convenience, the various names for a base station-type apparatus and functionality are used interchangeably in this patent document to refer to network infrastructure components that provide wireless access to remote terminals. Also, depending on the network type, the term “user equipment” (UE) can refer to any component such as a mobile station (MS), subscriber station (SS), remote terminal, wireless terminal, receive point, or user device. For the sake of convenience, the various names for a user equipment-type device and functionality are used interchangeably in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-119 include circuitry, programing, or a combination thereof. In certain embodiments, and one or more of the gNBs 101-103 includes circuitry, programing, or a combination thereof.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

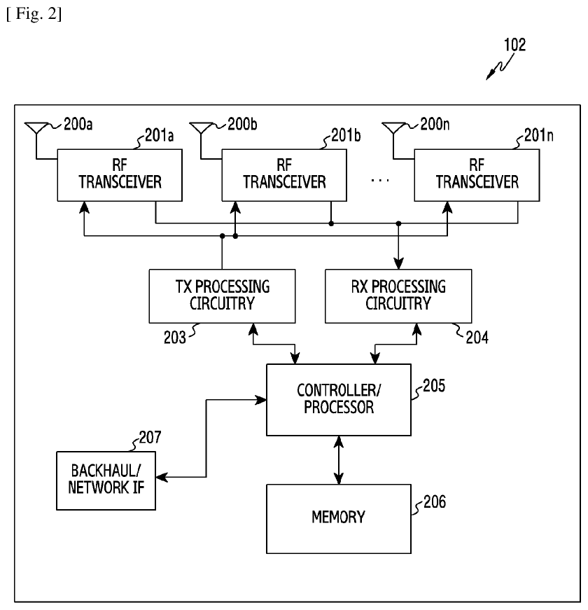

FIG. 2 illustrates an example base station according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

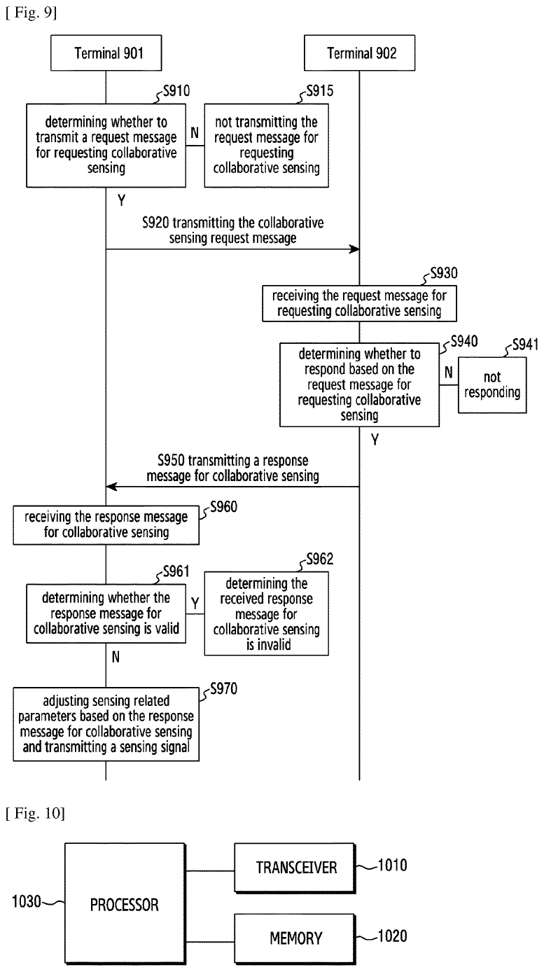

As shown in FIG. 2, the gNB 102 includes multiple antennas 200a-200n, multiple radio frequency (RF) transceivers 201a-201n, transmit (TX) processing circuitry 203, and receive (RX) processing circuitry 204. The gNB 102 also includes a controller/processor 205, a memory 206, and a backhaul or network interface 207. However, the components of the gNB 102 are not limited thereto. For example, the gNB 102 may include more or fewer components than those described above. In addition, the gNB 102 corresponds to the base station of the FIG. 10.

The RF transceivers 201a-201n receive, from the antennas 200a-200n, incoming RF signals, such as signals transmitted by UEs in the network 100. The RF transceivers 201a-201n down-convert the incoming RF signals to generate intermediate frequency (IF) or baseband signals. The IF or baseband signals are sent to the RX processing circuitry 204, which generates processed baseband signals by filtering, decoding, and/or digitizing the baseband or IF signals. The RX processing circuitry 204 transmits the processed baseband signals to the controller/processor 205 for further processing.

The TX processing circuitry 203 receives analog or digital data (such as voice data, web data, electronic mail, or interactive video game data) from the controller/processor 205. The TX processing circuitry 203 encodes, multiplexes, and/or digitizes the outgoing baseband data to generate processed baseband or IF signals. The RF transceivers 201a-201n receive the outgoing processed baseband or IF signals from the TX processing circuitry 203 and up-converts the baseband or IF signals to RF signals that are transmitted via the antennas 201a-201n.

The controller/processor 205 can include one or more processors or other processing devices that control the overall operation of the gNB 102. For example, the controller/processor 205 could control the reception of forward channel signals and the transmission of reverse channel signals by the RF transceivers 201a-201n, the RX processing circuitry 204, and the TX processing circuitry 203 in accordance with well-known principles. The controller/processor 205 could support additional functions as well, such as more advanced wireless communication functions.

For instance, the controller/processor 205 could support beam forming or directional routing operations in which outgoing signals from multiple antennas 200a-200n are weighted differently to effectively steer the outgoing signals in a desired direction. Any of a wide variety of other functions could be supported in the gNB 102 by the controller/processor 205.

The controller/processor 205 is also capable of executing programs and other processes resident in the memory 206, such as an operating system (OS). The controller/processor 205 can move data into or out of the memory 206 as required by an executing process.

The controller/processor 205 is also coupled to the backhaul or network interface 207. The backhaul or network interface 207 allows the gNB 102 to communicate with other devices or systems over a backhaul connection or over a network. The interface 207 could support communications over any suitable wired or wireless connection(s). For example, when the gNB 102 is implemented as part of a cellular communication system (such as one supporting 5G, LTE, or LTE-A), the interface 207 could allow the gNB 102 to communicate with other gNBs over a wired or wireless backhaul connection. When the gNB 102 is implemented as an access point, the interface 207 could allow the gNB 102 to communicate over a wired or wireless local area network or over a wired or wireless connection to a larger network (such as the Internet). The interface 207 includes any suitable structure supporting communications over a wired or wireless connection, such as an Ethernet or RF transceiver.

The memory 206 is coupled to the controller/processor 205. Part of the memory 206 could include a random access memory (RAM), and another part of the memory 206 could include a Flash memory or other read only memory (ROM).

Although FIG. 2 illustrates one example of gNB 102, various changes may be made to FIG. 2. For example, the gNB 102 could include any number of each component shown in FIG. 2. As a particular example, an access point could include a number of interfaces 207, and the controller/processor 205 could support routing functions to route data between different network addresses. As another particular example, while shown as including a single instance of TX processing circuitry 203 and a single instance of RX processing circuitry 204, the gNB 102 could include multiple instances of each (such as one per RF transceiver). Also, various components in FIG. 2 could be combined, further subdivided, or omitted and additional components could be added according to particular needs.

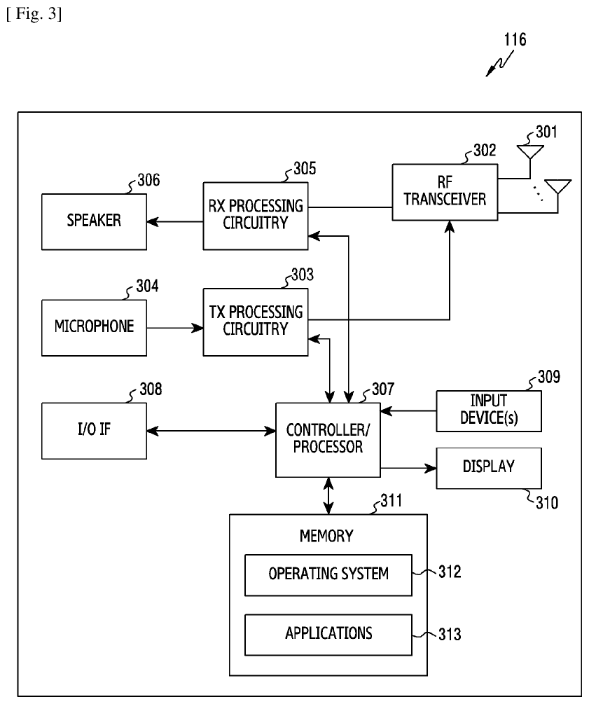

FIG. 3 illustrates an example user equipment according to embodiments of the present disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the present disclosure to any particular implementation of a UE.

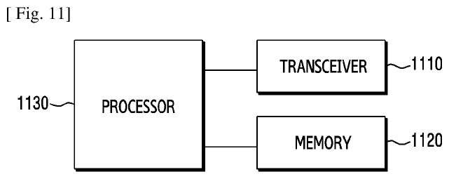

As shown in FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, a touchscreen display 310, and a memory 311. The memory 311 includes an OS 312 and one or more applications 313. However, the components of the UE 116 are not limited thereto. For example, the UE 116 may include more or fewer components than those described above. In addition, the UE 116 corresponds to the terminal of the FIG. 11.

The RF transceiver 302 receives, from the antenna 301, an incoming RF signal transmitted by an gNB of the network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments, the processor 307 includes at least one microprocessor or microcontroller.

The processor 307 is also capable of executing other processes and programs resident in the memory 311, such as processes for CSI reporting on uplink channel. The processor 307 can move data into or out of the memory 311 as required by an executing process. In some embodiments, the processor 307 is configured to execute the applications 313 based on the OS 312 or in response to signals received from gNBs or an operator. The processor 307 is also coupled to the I/O interface 309, which provides the UE 116 with the ability to connect to other devices, such as laptop computers and handheld computers. The I/O interface 309 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include a Flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

With the advancement of science and technology, there is an increasing variety of communication devices. In addition to traditional devices such as mobile phones and computers, mobile robots such as autonomous vehicles and drones may also be included. These types of mobile devices often require the ability to locate accurately or be located accurately, in order to identify the current situation accurately and respond accordingly, that is, these devices possess positioning capability similar to that provided by radar technology. One direct approach could be to equip communication devices with radar modules. However, in recent years, as the working frequency band of communication systems has gradually developed towards higher frequencies, the communication frequency band has also gradually approached the radar frequency band, resulting in inevitable interference and resource conflicts between communication systems and radar systems. One approach to solving the problem can be considering a fusion system of communication and radar, known as communication sensing integration technology, which further enhances the functionality of the communication system and improves spectral efficiency. Currently, both the industry and academia consider the communication sensing integration as one of the key technologies for future communication systems.

The key concept of the communication sensing integration is to use the same set of hardware devices, ensuring basic communication functions, to achieve the sensing function of the surrounding environment at the cost of minimizing resource overhead as much as possible. That is, the nodes used for the communication sensing integration also have sensing functions, and sensed information includes the distance, direction, velocity, direction of movement, and even the type of objects in the surrounding environment. Unlike the positioning techniques used in traditional communication systems for access terminals, communication sensing integration technology can also achieve the sensing of various information of non-access objects, which significantly increases the ability of communication systems to dynamically adjust their working status (scheduling, beam management, early warning of access terminals, etc.) based on the surrounding environment. Therefore, it is necessary to enhance the communication and/or sensing processes of nodes used for communication sensing integration.

In this regard, the present disclosure mainly relates to the sensing function and/or communication function of nodes used for communication sensing integration. A node used for communication sensing integration and a method performed by the node are proposed. According to the disclosed embodiments, the communication integration node and the method performed by the node can achieve more accurate sensing and/or received signal estimation, alternatively, according to the disclosed embodiments, the communication integration node and the method performed by the node can achieve more accurate sensing (such as achieving more accurate angle estimation) and/or received signal estimation with less resource overhead. The nodes used for communication sensing integration are hereinafter referred to as sensing communication nodes. In this application, there is no restriction on the naming of nodes used for communication sensing integration, and they may also be referred to as synesthesia nodes, etc. The sensing communication node may be any wireless communication device, such as a base station, terminal equipment, sidelink equipment (such as a sidelink UE), and so on.

Currently, the most widely used communication systems are based on the 3GPP protocol, such as 4G communication systems such as LTE and LTE-A, and 5G communication systems such as NR. The signal waveforms used in these communication systems are based on OFDM modulation. Considering forward compatibility, for example, OFDM communication signals may be used as sensing signals. Sensing signals may be physical signals and/or physical channels that are used for the purpose of sensing. For example, when the sensing node is a base station, the sensing signal may be a downlink reference signal or a downlink physical channel, etc; When the sensing node is a terminal, the sensing signal may be an uplink reference signal, a sidelink reference signal, or an uplink physical channel. The sensing signal transmitted by the sensing node is reflected by the target and then received by the sensing node in the form of a echo signal. By processing the echo signal, the sensing information of the target, such as distance, velocity, orientation, and direction of movement, may be sensed.

For example, in the scenario of the Vehicle-to-Everything (V2X), the situation of “blind-spot accidents” is common. During travelling, the sensing module of a vehicle may fail to accurately detect moving targets (such as pedestrians, motor vehicles, non-motorized vehicles, etc.) within the blind spots of obstacle detection, which results in serious traffic accidents due to inability to slow down or brake in a timely manner. For example, parked vehicles or obstacles at the roadside may cause blind spots for vehicles travelling on the road; when changing lanes and overtaking, the vehicles moving slowly ahead which will be overtaken may cause a blind spot for vehicle attempting to change lanes behind them; when waiting at traffic lights, vehicles waiting to turn may cause a blind spot for vehicles going straight. The above problems are all caused by insufficient environmental sensing information. Due to the limited sensing range of vehicles, there is a lack of comprehensive sensing information, which makes it difficult to detect nearby dangers in time. For traditional long-distance (10 m-250 m) millimeter wave radar, the sensing angle range of its horizontal angle is typically ±15 degrees; For medium-distance (1-100 m) millimeter wave radar, the sensing angle range of its horizontal angle is typically ±45 degrees. Therefore, objects out of this sensing angle range need to be sensed through other means, such as adding additional sensors, which increases costs. In addition, in the V2X, radar sensing usually requires time-varying scanning beams to estimate and detect targets within a larger range. During the radar scanning process, it is affected by interference signals and clutter, leading to a decrease in detection performance.

For example, in radar technology, the received echo signal is processed by a matched filter, and then a narrow pulse signal with sinc function characteristics is output, including main lobe and side lobe. If the power of side lobe is too high, it will cause the target corresponding to the low-power echo signal to be submerged in the side lobe of the target corresponding to the high-power echo signal, resulting in missed detection. In side lobe suppression technology, antenna array elements are typically weighted using window function or spatial filtering, and the weight of each element is changed, to suppress the power of side lobe. However, while suppressing the power of side lobe, the main lobe of the beam will be broadened, resulting in loss of signal-to-noise ratio and decrease in resolution. Moreover, in the case of severe clutter or interference, better side lobe suppression capability is often required to improve target detection performance, but achieving better side lobe suppression often means further broadening the main lobe.

In some embodiments, the present disclosure provides a mechanism for terminal adaptive beam adjustment to address the issue of limited detection caused by the blind spot of sensing. For example, a first node (e.g., terminal) can adaptively adjust the sensing beam based on sensing results, or the first node (e.g., terminal) can assist in switching the sensing beam based on the sensing information of other terminals by transmitting a request message for requesting collaborative sensing to the second node (e.g., other terminal, base station, or roadside unit), select a specific shape of beam, obtain at least one of the following sensing information through a higher power of side lobe within a specific angle range: distance, velocity, angle, and direction of movement while ensuring the sensing and/or communication performance in the direction of the main lobe. Alternatively, by increasing the power of side lobe to expand the sensing range, the problem of limited sensing angle range in traditional millimeter wave radar can be solved; alternatively, by reducing power of side lobe within a specific angle range, clutter or interference can be suppressed to achieve better sensing performance. In the scenario of V2X, the method provided in the present disclosure can not only improve sensing accuracy, increase sensing range, reduce latency, but also provide terminals with more accurate and comprehensive real-time environmental information. In addition, applying collaborative sensing in V2X environment can reduce the number of onboard sensors and reduce the cost of autonomous vehicle. It should be noted that in the disclosed embodiments, the transmission of the terminal device can be used for both the sidelink and the uplink of the cellular link; alternatively, the reception of terminal device can be used for both the sidelink and the downlink of the cellular link. This disclosed embodiment does not limit this.

The embodiments described herein can use V2X communication to transmit and receive wireless messages. As described herein, examples of V2X communication include but are not limited to one or more of the following: Dedicated Short-Range Communication (DSRC) (including Basic Security Messages (BSMs) and Personal Security Messages (PSMs), as well as other types of DSRC communication); Long-Term Evolution (LTE); mmWave communication; 3G; 4G; 5G; LTE-V2X; 5G-V2X; LTE Vehicle-to-Vehicle (LTE-V2V); LTE Device-to-Device (LTE-D2D); LTE Voice (VoLTE), and so on. In some examples, V2X communication can include V2V communication, Vehicle-to-Infrastructure (V2I) communication, Vehicle-to-Network (V2N) communication, or any combination thereof.

Examples of wireless message (e.g., V2X messages) described herein include but are not limited to the following message: DSRC message; BSM; LTE message; LTE-V2X message (e.g., LTE-V2V message, LTE-V2I messages LTE-V2N message, etc.); 5G-V2X message; and mmWave message, among others.

Further descriptions of exemplary embodiments are provided below in conjunction with the accompanying drawings.

The text and accompanying drawings are provided as examples only to assist readers in understanding the present disclosure. They are not intended and should not be interpreted to limit the scope of the present disclosure in any way. Although certain embodiments and examples have been provided, it will be apparent to those skilled in the art, based on the disclosure herein, that changes can be made to the illustrated embodiments and examples without departing from the scope of the present disclosure.

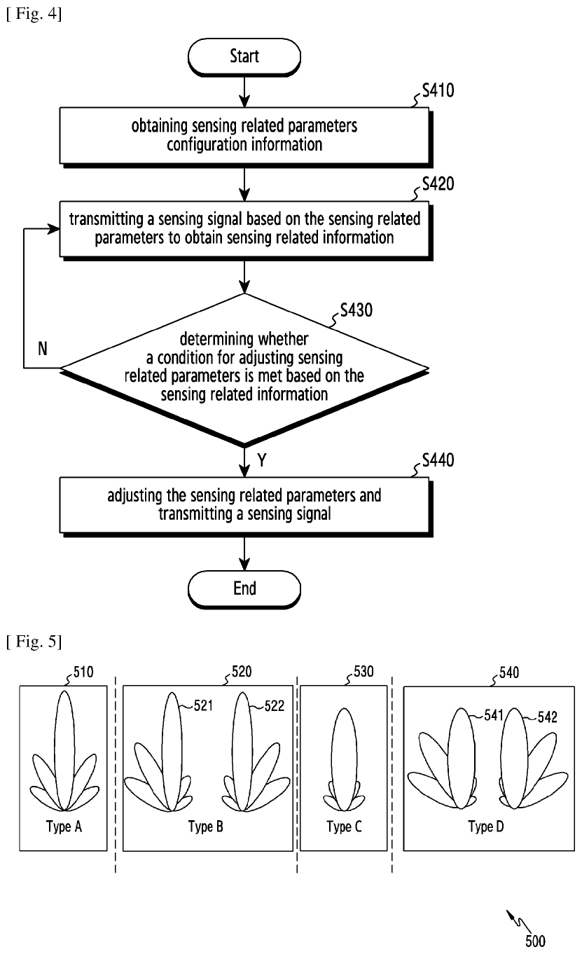

FIG. 4 illustrates a flowchart of a method for adaptively adjusting beam scanning parameters by a terminal based on the sensing information of targets.

In one embodiment shown in FIG. 4, a method for adaptively adjusting beam scanning parameters based on sensing information of the surrounding environment is shown. The method of this embodiment is applicable to cases where the first node (such as a terminal) self-transmits and self-receives or senses based on the transmission information of other nodes (such as other terminals). The following takes the terminal as an example.

At S410, the terminal can obtain configuration information including sensing related parameters (such as beam scanning parameter configuration) from at least one of the following nodes: base station, other terminals, and Road Side Unit. The configuration information may include at least one of the following: beam scanning mode, single or multiple beam scanning ranges, wherein each beam scanning range may also be configured with beam scanning period, beam scanning interval, beam type, angle of main lobe beam, power of main lobe beam, peak side lobe ratio, and the beam set used within each beam scanning range, wherein the beam set may be preset according to different scenarios. The means of configuration may be configured statically, configured semi-statically, or configured dynamically. The sensing related parameters herein may be referred to as a first parameter, and this application does not limit its name.

In this embodiment, the terminal may have a single or multiple antenna arrays, and each antenna array has multiple antenna array elements. For an antenna with multiple antenna array elements, different beamforming functions, also known as spatial filters, can be implemented by adjusting the weight of each antenna array element, wherein the weight can change the amplitude and/or phase of the signal on each antenna element. By using different beamforming functions or spatial filters, beams of different shapes can be formed, such as different directions of main lobe, widths of main lobe, peak side lobe ratios, etc. Beam scanning implemented by the terminal generally refers to beam scanning at intervals of 3 dB beamwidth within a certain beam scanning range. The period T of beam scanning is related to the radio frames used in beam scanning, the radio frames are a set of communication resources (e.g., frequency resources and time resources) used by the beam to complete one round of beam scanning within the beam scanning range. The resources occupied by this communication resource set can be received by at least one of the following nodes: base station, terminal, road side unit. The means of configuration may be configured statically, configured semi-statically, or configured dynamically. For example, when a terminal performs beam scanning on the surrounding environment, the target in the surrounding environment can be at least one of the following: a terminal with communication capability, a terminal without communication capability, or any object capable of reflecting sensing signal. Terminals with communication capability can be terminals connected to the core network or terminals not connected to the core network.

In this embodiment, when the terminal performs beam scanning, it can transmit wide or narrow beams for scanning. The wide beams, relative to the narrow beams, have a width greater than or equal to the width of the narrow beams. The wide beams can cover the terminal within a larger angle range than the narrow beams. The beamwidth of wide beams can be greater than or equal to a preset beamwidth (e.g., a first preset beamwidth can be 10 degrees), while the beamwidth of narrow beams can be less than or equal to the preset beamwidth. The preset beamwidth is configurable, and its value depends on the density of targets in the environment. When the targets in the environment are relatively scattered, wide beams can be selected for scanning. The wide beams can be used to detect more targets and reduce the sensing latency of the targets in the environment. However, the wide beams have lower power than that of the narrow beams, which limits the detection range of the wide beams compared to the narrow beams. When targets are located at a remote distance, using narrow beams can improve detection performance.

Alternatively, when the terminal performs beam scanning, in addition to transmitting regular beams with symmetrical side lobes for scanning, it can also transmit beams with irregular side lobes for scanning.

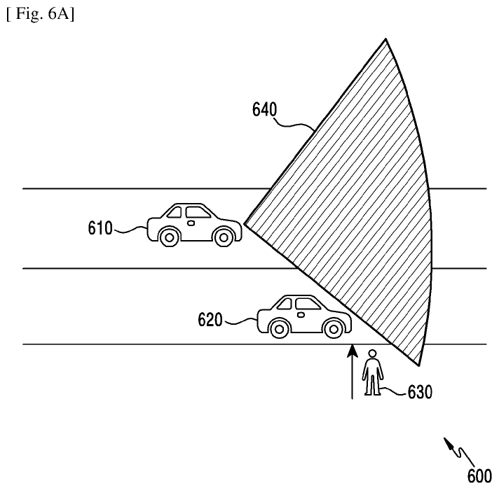

FIG. 5 illustrates an example of beams of different shapes. Under the condition of a fixed antenna aperture, there are beams with different shapes as shown in FIG. 5. In beam pattern 500, there are four different types of beam: Beam Type 510 (Type A), Beam Type 520 (Type B), Beam Type 530 (Type C), and Beam Type 540 (Type D), wherein the characteristic of Type A beam is the narrowest width of main lobe, highest power of main lobe, and highest power of side lobe. Based on the Type A beam, optimized beams, i.e, the beams of Types B, C, and D, can be obtained by adjusting the amplitude and phase of signals on the antenna elements. For example, the beam of Type B maintains the same width of main lobe and power of main lobe as the beam of Type A but has decreased side lobes on the right and increased side lobes on the left, represented by beam type 521, or has decreased side lobes on the left and increased side lobes on the right, represented by beam type 522. The beam of Type C has a slightly increased width of main lobe and slightly decreased power of main lobe, with significantly decreased power in the side lobes compared to the Type A beam. The beam of type D has a slightly increased width of main lobe and can have a type with slightly decreased power of main lobe, significantly decreased side lobes on the right, and significantly increased side lobes on the left, represented by Beam Type 541, or a type with slightly decreased power of main lobe, significantly decreased side lobes on the left, and significantly increased side lobes on the right, represented by Beam Type 542.

In addition to the four beam types shown in FIG. 5, there can also be other beam types. For example, while maintaining a certain power for the main lobe, the power of the side lobes corresponding to the direction θ can be designed, such that the power ratio of the side lobe corresponding to the direction θ to the main lobe is greater than or equal to k, wherein the value of the direction θ is within the beam scanning range [θ₁, θ₂] of the terminal, and the power ratio k is related to the sensing performance requirements. As k increases, the performance of communication or sensing in the direction of main lobe is affected due to the decrease in power of main lobe. On the other hand, as k decreases, the performance of sensing utilizing side lobes is improved. One possible criterion for selecting k is to ensure the performance of communication or sensing in the main lobe and then increase the value of k to enhance the performance of sensing utilizing side lobes. The advantages of defining and utilizing beams of different beam types for sensing is that beam types with low side lobe can be utilized to reduce the performance impact of clutter or interference entering the angle of side lobe on main lobe sensing and/or communication. In addition, the beam in beam type with high side lobe can also be used to achieve communication using the communication link established by the main lobe, and to sense potential targets within the blind spot through side lobes.

For example, when millimeter wave is used for communication, due to limitations in size and cost, a typical single millimeter wave antenna panel only has one RF link, and the antenna panel can only perform analog beamforming to form a beam with only one main lobe. When the main lobe of the beam is used for communication, it is impossible to utilize the main lobe for beam scanning and achieve sensing capability. In order to achieve integration of communication and sensing, which can achieve sensing function using communication beams, the side lobes of the beam can be designed and used for sensing.

In the embodiments of the present disclosure, the beam used by terminal for scanning can have at least one of the following beam parameters: angle of main lobe, width of main lobe, power of main lobe, peak side lobe ratio (e.g., power ratio between the strongest side lobe and the main lobe), etc. According to different parameters, different types of beams can be generated, the different types of beams can be generated based on the DFT (Discrete Fourier Transform) codebook; the different types of beams can also be generated through adaptive algorithms (e.g., online generation), including Least Mean Square (LMS) algorithm or neural network-based algorithm among others. It should be noted that the values of the beam parameters mentioned above used to generate different types of beams can be generated by the terminal based on scenario requirements or determined based on information from other terminals. These values can also be obtained through at least one of the following means from other nodes (such as base stations, other terminals): downlink control information, sidelink control information, physical downlink shared channel, physical downlink control channel, physical sidelink shared channel, physical sidelink control channel, and high-layer signaling (e.g., RRC signaling, MAC signaling, etc.).

In different sensing scenarios, different beams can be generated based on the type of beam, angle of main lobe, width of main lobe, power of main lobe, and peak side lobe ratio. For example, Table 1 shows the configuration of beams corresponding to beam Type A, wherein the angle of main lobe θᵢ, i=1, . . . , G, G is the number of beams, and G is an integer greater than or equal to 1; the width of main lobe

$${w}_{j}^{i} ,$$

i=1, . . . G, j=1, . . . N, N is the number of widths of main lobe that can be configured at the angle of main lobe θᵢ, i=1, . . . , G; the power of main lobe

$${p}_{j , l}^{i} ,$$

i=1, . . . . G, j=1, . . . N, l=1, . . . , M, M is the number of the power of main lobe that can be configured at the angle of main lobe θᵢ, i=1, . . . , G and the width of main lobe

$${w}_{j}^{i} ,$$

i=1, . . . G, j=1, . . . N, pean side lobe ratio

$${k}_{j , l}^{i} ,$$

i=1, . . . G, j=1, . . . N, l=1, . . . , P, P is the number of the peak side lobe ratios that can be configured at the angle of main lobe θᵢ, i=1, . . . , G and the width of main lobe

$${w}_{j}^{i} ,$$

i=1, . . . G, j=1, . . . N. For example, in power normalization, different peak side lobe ratios can correspond to different shapes of side lobes. For example, beams of different beam types can be configured with different angles of main lobe, and/or different widths of main lobe, and/or different peak side lobe ratios. In the case of the same beam type, different angles of main lobe can correspond to different numbers of configurable widths of main lobe. In the case of different widths of main lobe, the configurable peak side lobe ratios can also vary, making beam configuration more flexible.

TABLE 1

| | angle of | width of | power of | |
|---|---|---|---|---|
| beam type | main lobe | main lobe | main lobe | peak side lobe ratio |
| A | θ₁ | ${w}_{1}^{1}$ | ${p}_{1 , 1}^{1}$ | $\{ {k}_{1 , 1}^{1} , … , {k}_{1 , P}^{1} \}$ |
| | | | . . . | |
| | | | ${p}_{1 , M}^{1}$ | |
| | | . . . | . . . | . . . |
| | | ${w}_{N}^{1}$ | ${p}_{N , 1}^{1}$ | $\{ {k}_{N , 1}^{1} , … , {k}_{N , P}^{1} \}$ |
| | | | . . . | |
| | | | ${p}_{N , M}^{1}$ | |
| | . . . | . . . | . . . | . . , |
| | θ_{G} | ${w}_{1}^{G}$ | ${p}_{1 , 1}^{G}$ | $\{ {k}_{1 , 1}^{G} , … , {k}_{1 , P}^{G} \}$ |
| | | | . . . | |
| | | | ${p}_{1 , M}^{G}$ | |
| | | . . . | . . . | . . . |
| | | ${w}_{{N}^{′}}^{G}$ | ${p}_{N , 1}^{G}$ | $\{ {k}_{N , 1}^{G} , … , {k}_{N , P}^{G} \}$ |
| | | | . . . | |
| | | | ${p}_{N , M}^{G}$ | |

Alternatively, when the terminal performs beam scanning, it can select a uniform beam scanning mode or a non-uniform beam scanning mode. For example, the uniform beam scanning mode can use a first preset beam scanning interval for scanning within the angle range [θ₁, θ₂]; the non-uniform beam scanning mode can be divided into different beam scanning ranges. For example, a second preset beam scanning interval for scanning can be used within the angle range [θ₃, θ₄], and a third preset beam scanning interval can be used within the angle range [θ₅, θ₆], wherein the range of the scanning angle θᵢ, i=1, 2, . . . , G is [−90°, 90°], and G is the number of beams.

At S420, the terminal performs beam configuration based on the received sensing related parameters, and then transmits a sensing signal based on the configured beam, performs beam scanning on the surrounding environment, and obtains sensing information of the surrounding environment, wherein the sensing signal can be referred to as a first signal.

Wherein the parameters for the terminal to perform beam scanning are the beam scanning configuration parameters obtained by the terminal in S410. The sensing signal transmitted by the terminal can be at least one of the following: downlink signal, uplink signal, and sidelink signal. For example, the downlink signal includes at least one of the following: demodulation reference signal, channel state information reference signal, synchronization signal, physical downlink shared channel, and physical downlink control channel. For another example, the uplink signal includes at least one of the following: demodulation reference signal, sounding reference signal, physical uplink shared channel, and physical uplink control channel. For another example, the sidelink signal includes at least one of the following: sidelink reference signal, sidelink synchronization signal, physical sidelink shared channel, and physical sidelink control channel.

For example, when performing beam scanning, the terminal can receive echo signal reflected from a target in the surrounding environment, where the target can be referred to as a first target. Based on the echo signal of the transmitted sensing signal, the terminal can obtain at least one of the following sensing information: the distance d of the target within the sensing range relative to the terminal, the angle θ of the target within the sensing range relative to the terminal, the velocity V of the target within the sensing range relative to the terminal, and the radial direction of movement of the target within the sensing range relative to the terminal. For example, based on the time domain channel estimation result of a single received echo signal, the terminal can obtain a distance estimation value of the target. Alternatively, the terminal can also obtain estimations of distance and velocity of the target based on the time domain channel estimation result of multiple received echo signals. The angle of the target in the sensing information can be roughly estimated through the beam angle during terminal beam scanning, while accurate estimation of angle can be achieved through differential beamforming or super-resolution algorithms based on subspace decomposition.

At S430, based on the sensing information obtained from S420, the terminal determines whether the conditions for adjusting the sensing related parameters (beam scanning parameters) are met (such as the first condition).

Wherein the conditions for the adjustment of beam scanning parameters can be at least one of the following conditions:

(1) The terminal obtains configuration information including sensing related parameters (such as beam scanning parameter configuration) from at least one of the following nodes: base station, other terminals, Road Side Unit. The terminal obtains the relevant configuration through at least one of the following: downlink control information, sidelink control information, physical downlink shared channel, physical downlink control channel, physical sidelink shared channel, physical sidelink control channel, high-layer signaling (e.g., RRC signaling, MAC signaling). Wherein the configuration information includes at least one of the following: beam scanning mode, single or multiple beam scanning ranges, wherein each beam scanning range can also be configured with beam scanning period, beam scanning interval, beam type, angle of main lobe beam, power of main lobe beam, peak side lobe ratio, beam scanning mode, and beam set used within each beam scanning range, wherein the beam set can be preset based on different scenarios. It should be noted that the configuration information can be configured dynamically or semi-statically by other nodes based on the position (latitude and longitude) of the terminal and other terminals. The configuration information can be referred to as a second configuration information, and the sensing related parameters here can be referred to as a second parameter. Furthermore, the type of parameter included in the second parameter can be different, the same, or partially the same as the type of parameter included in the first parameter. When the type of parameter included in the second parameter can be the same or partially the same as the type of parameter included in the first parameter, the value of the parameter can be different.

(2) The power of the time-domain channel estimation result of the target's echo signal is greater than or equal to a power threshold Pₜₕ, which can be referred to as a first threshold value, wherein Pₜₕ is a number greater than or equal to zero, and its typical value can be a power greater than the noise floor, wherein the noise floor can be a theoretical value or a measured value. For example, the terminal performs channel estimation based on the echo signals of a single or multiple sensing signals to obtain single or multiple time domain channel estimation results. For multiple time domain channel estimation results, the terminal can take their average as the final time domain channel estimation result.

(3) The power of the Doppler domain channel estimation result of the target's echo signal is greater than or equal to a power threshold pdₜₕ, which can be referred to as a second threshold value, wherein pdₜₕ is a number greater than or equal to zero, and its typical value can be a power greater than the noise floor, wherein the noise floor can be a theoretical value or a measured value. For example, the terminal can obtain the Doppler domain channel estimation result of the target based on the echo signals of a single or multiple sensing signals

(4) The distance d of the target relative to the terminal is less than or equal to dₜₕ, which can be referred to as a first threshold, wherein dₜₕ is a number greater than or equal to zero. For example, the terminal can determine the distance of the target based on the time domain channel estimation result of the echo signals of a single or multiple sensing signals. For example, the terminal can use the estimated value of a single target distance or the average value of multiple target distance measurements as the final distance measurement;

(5) The angle θ of the target is within the set angle range [β₁, β₂], wherein the zero direction of the angle is the direction of the movement of the terminal, and −π/2≤β₁<β₂≤π/2.

(6) The position of the target remains unchanged or the change in position is less than or equal to the second threshold within a first time range, wherein the terminal can determine the position information of other terminals, such as longitude and latitude, based on the sensing information.

In this embodiment of the present disclosure, the power threshold, the distance threshold dₜₕ, the angle range [β₁, β₂], the second threshold, and the first time range can be preset values or determined based on information from other terminals, or relevant configurations can be obtained through at least one of the following: downlink link control information, sidelink control information, physical downlink shared channel, physical downlink control channel, physical sidelink shared channel, physical sidelink control channels, high-layer signaling (e.g., RRC signaling, MAC signaling). The terminal determines whether the conditions for adjusting the beam scanning parameters are met based on the sensing information obtained from S420. If the conditions are met, proceeds to S440; otherwise, proceeds to S420.

Since the terminal only transmits signals for sensing within a fixed distance and/or angle range, it not only reduces the cost and complexity of communication resources, but also ensures that the delay in transmitting messages for collaborative sensing meets a certain low latency requirement. Additionally, the method based on time domain channel estimation result of echo signals can reduce the impact of echo signals with lower power or power lower than the clutter power due to lower reflection coefficients or interference from clutter at other terminals, and improve the sensing performance of the terminal. Moreover, utilizing the target's position can mitigate the decrease in reliability of sensing information caused by drastic changes in the target's position.

At S440, based on sensing related information, the terminal transmits a first signal for sensing (e.g., a sensing signal).

For example, the terminal adjusts sensing related parameters and transmits a sensing signal for sensing based on the adjusted sensing related parameters, such as performing beam scanning using a beam set determined by the adjusted beam scanning parameters. The beam scanning parameters include at least one of the following parameters: beam scanning mode, single or multiple beam scanning ranges. Wherein each beam scanning range can also be configured with at least one of the beam scanning period, beam scanning interval, beam type, angle of main lobe beam, power of main lobe beam, and peak side lobe ratio. Alternatively, the terminal obtains configuration information from the base station or other terminals, the configuration information includes at least one of the following: beam scanning mode, single or multiple beam scanning ranges, and the beam set used within each beam scanning range.

Alternatively, the beam scanning range (sensing angle range) of terminal can be preset. For example, a larger beam scanning range may be used when the distance of the target is less than or equal to dₜₕ; a smaller beam scanning range may be used when the distance of the target is greater than to dₜₕ. Alternatively, the beam scanning range of the terminal can be determined dynamically based on the sensing results. For example, when the position of the target relative to the terminal changes, the terminal can also determine the beam scanning range dynamically based on the latest sensing information obtained from beam scanning.

Alternatively, the terminal can select different beam scanning periods (frequencies) for different beam scanning ranges. For example, the terminal can use a lower beam scanning frequency, i.e. a longer beam scanning period, for non-blind spots or target-free ranges. On the other hand, a higher beam scanning frequency, i.e., a shorter beam scanning period, can be used for blind or potentially blind spot ranges. The range of blind spots varies depending on the sensing angle range of the terminal. When the sensing angle range of the terminal is large, the blind spot range of the terminal is small, while when the sensing angle range of the terminal is small, the blind spot range of the terminal is large. When the terminal has a larger sensing angle range, the corresponding sensing delay is higher. Therefore, when the terminal determines the possible blind spot range, it can expand the scanning range for the blind spot and/or increase the beam scanning frequency, thereby reducing the blind spot range, decreasing sensing delay of blind spot, and improving sensing accuracy within the blind spot.

Alternatively, the terminal can use either a non-adaptive or adaptive method for selecting beams from the beam set for beam scanning. In the non-adaptive method, scanning can be performed at a fixed angle interval, a fixed angle interval of main lobes can be 3 dB beamwidth. Alternatively, scanning can be performed at a non-fixed angle interval. For example, a wide beam with a larger angle interval can be initially used for coarse scanning, and then a narrow beam with a smaller angle interval can be used for fine scanning within the angle range where the target exists. The adaptive method can, based on the sensing information obtained by processing and analyzing echo signal, select appropriate beam scanning parameters or beam set adaptively for beam scanning to sense. Alternatively, the terminal can perform beam scanning based on the beam set determined by the beam scanning parameters adjusted in S440, and then determine whether the conditions described in S430 for adjusting the beam scanning parameters are met based on the new obtained sensing results. If so, the beam scanning parameters can be adjusted based on the new sensing results (detailed process can be seen in S440). Alternatively, the terminal obtains configuration information including sensing related parameters (such as beam scanning parameter configuration) from at least one of the following nodes: base station, other terminals, Road Side Unit. The terminal obtains relevant configuration through at least one of the following: downlink control information, sidelink control information, physical downlink shared channel, physical downlink control channel, physical sidelink shared channel, physical sidelink control channel, high-layer signaling (e.g., RRC signaling, MAC signaling). The configuration can be obtained dynamically or semi-statically.

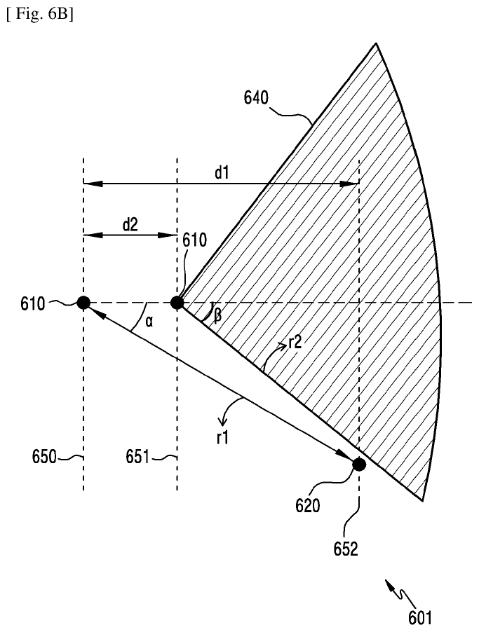

FIG. 6A illustrates an example of a beam scanning range.

FIG. 6A shows a possible scenario 600 in this embodiment, in the scenario, 640 represents the beam scanning range, i.e., the sensing range, of terminal 610 using the first beam set. The characteristics of the first beam set can be a wide beam of beam type A, uniform beam scanning, and the area outside range 640 can be considered as the blind spot of the terminal, in the blind spot, the terminal cannot sense any targets. For example, the blind spot can be caused by the obstruction of terminal 620 or the limited beam scanning range of terminal 610. In scenario 600, 630 is a pedestrian moving toward the lane where terminal 610 is located within the blind spot of the terminal 610. It should be noted that 630 can represent not only pedestrians but also moving terminals such as vehicles or non-motorized vehicles.

FIG. 6B illustrates an example of adaptive beam selection and dynamic determination of beam scanning range based on echo signals.

FIG. 6B illustrates an example where terminal 610 selects beams adaptively and determines the beam scanning range dynamically based on the echo signals from surrounding targets. In scenario 601, terminal 610 and terminal 620 are abstracted as point targets. A distance r₁ and a corresponding angle α of terminal 620 are sensed by terminal 610 at time 650. Based on the above sensing information, terminal 610 can calculate distance as d1=r×cos α, which can be considered as the remaining distance that terminal 610 may encounter a collision. Based on the velocity v₀ of terminal 610 itself, terminal 610 then can calculate the remaining time t=d1/v₀ that a collision may occur (assuming that terminal 610 is moving to the right as shown in the figure, and a collision may occur at time 652), terminal 610 can choose to change the beam set for beam scanning at time 651 after moving a distance of d2. The selection at time 651 can be based on the distance and/or angle of terminal 620 sensed by terminal 610, for example, when terminal 610 senses that the distance r₂ of terminal 620 is less than or equal to the distance threshold rₜₕ, and/or when terminal 610 senses that the absolute value of the angle β of terminal 620 is greater than or equal to the angle threshold βₜₕ, where the range of values for β and βₜₕ is [−90°,90°]. It should be noted that the distance threshold rₜₕ and angle threshold βₜₕ can be preset by terminal 610, can be determined based on information from other terminals, or relevant configurations can be obtained through at least one of the following: downlink control information, sidelink control information, physical downlink shared channel, physical downlink control channel, physical sidelink shared channel, and physical sidelink control channel, or high-layer signaling (e.g., RRC signaling, MAC signaling, etc.).

FIG. 6C illustrates an example of changing the beam set.

As shown in FIG. 6C, scenario 602 shows that terminal 610 changes the beam set at time 651. The method of changing the beam set can be adaptive or performed based on notifications from other terminals or base stations. In this example, terminal 610 adaptively changes the beam set based on the sensing information of terminal 620 at time 650. In scenario 602, terminal 610 changes from the first beam set to a non-uniform scanning mode at time 651, that is, changes to the second and third beam sets for scanning. The scanning range of the first beam set is 640, while the scanning ranges of the second and third beam sets are 641 and 642, respectively. The characteristics of the second beam set can be the same as those of the first beam set, or it can increase the period of beam scanning (reduce the frequency of beam scanning) and/or increase the angle interval of the beams in the beam set while ensuring uniform beam scanning, so that the terminal 610 can reduce the sensing delay for beam scanning within the beam scanning range 641. The characteristics of the third beam set can be the same as the first beam set, or it can reduce the beam scanning period (increase the frequency of beam scanning) and/or reduce the angle interval of the beams in the beam set while ensuring uniform beam scanning, so that the beam scanning within the beam scanning range 642 of the terminal 610 can be more precise, avoiding missed detection caused by the target being at the zero-power position of the beam, and the reduced beam scanning period can ensure faster scanning to potential targets within the range 642. It should be noted that the beam scanning range of terminal 610 is the union of the scanning ranges corresponding to the second and third beam sets. The scanning range of terminal 610 can be different from the scanning range 640 in scenario 601. For example, when terminal 601 keeps the beam scanning range unchanged, targets within the blind spot range may not be sensed by terminal 601. Terminal 610 can reduce the blind spot range by expanding the beam scanning range. Note that 620 can be a terminal or an unknown obstacle.

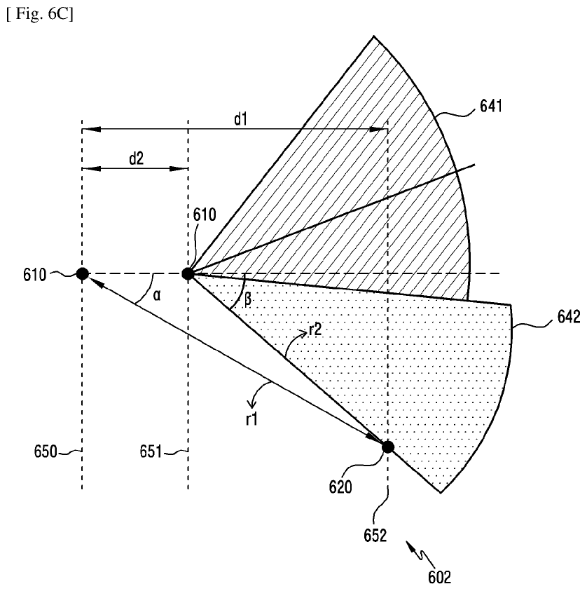

FIG. 7 illustrates a flowchart of a method for adjusting beam scanning parameters through collaborative sensing between terminals.

shown in FIG. 7, FIG. 7 illustrates a flowchart of the method for collaborative sensing between terminals according to the disclosed embodiment. The method in this embodiment is applicable to situations where terminals assist in beam sensing through collaborative sensing, reduce clutter or interference, and expand the sensing range. The method in this embodiment includes the following steps:

S710: Terminal 701 determines whether the condition for transmitting a request message for requesting collaborative sensing (such as a second condition) is met. If the condition is met, proceeds to S720; if the condition is not met, proceeds to S715.

In this embodiment, terminal 701 can also obtain sensing information such as distance, angle, velocity, and direction of movement of other terminals relative to terminal 701 by transmitting signals for sensing. The signal used for sensing can be referred to as a third signal, and based on the sensing information, terminal 701 can determine whether to transmit a request message for requesting collaborative sensing. Additionally, terminal 701 may detect (sense) a plurality of other terminals. For example, when performing beam scanning, terminal 701 can detect and sense other terminals at different beam angles, and the distance of terminals sensed at different angles may vary.

Wherein the conditions for terminal 701 transmitting a request message for requesting collaborative sensing can be at least one of the following conditions:

(1) Terminal 701 obtains configuration information from other nodes. For example, terminal 701 can obtain configuration information including sensing related parameters (such as beam scanning parameter configuration) from at least one of the following nodes: base station, other terminals, Road Side Unit. Terminal 701 obtains the relevant configurations through at least one of the following: downlink control information, sidelink control information, physical downlink shared channel, physical downlink control channel, physical sidelink shared channel, physical sidelink control channel, high-layer signaling (e.g., RRC signaling, MAC signaling). The configurations can be obtained dynamically or semi-statically. The configuration information includes at least one of the following: the number of terminals available for collaborative sensing, the location information of terminals available for collaborative sensing, and the sensing accuracy of terminals available for collaborative sensing.

(2) The distance d of other terminals relative to terminal 701 is less than or equal to dₜₕ, wherein dₜₕ can be referred to as a third threshold and is a positive number greater than or equal to zero. For example, terminal 701 can select the closest terminal from a plurality of terminals and transmit a request message for requesting collaborative sensing to the terminal. Alternatively, terminal 701 can select terminals with distance relative to the terminal 701 less than or equal to the third threshold from a plurality of terminals and transmit the request message for requesting collaborative sensing. The third threshold can be a value preset by terminal 701, or can be a value determined based on information from other terminals, or relevant configuration can be obtained through at least one of the following channels: downlink control information, sidelink control information, physical downlink shared channel, physical downlink control channel, physical sidelink shared channel, physical sidelink control channel, high-layer signaling (e.g., RRC signaling, MAC signaling, etc.). Since the request message for requesting collaborative sensing is only transmitted to the closest terminal or terminals with distance relative the terminal 701 meeting the third threshold, the delay caused by message propagation can be effectively reduced, and the validity of the messages can be improved. It should be noted that when no other terminals are detected by the terminal 701, or when all detected terminals are at distance relative to terminal 701 less than the third threshold, terminal 701 does not transmit the message for collaborative sensing.

(3) The angles θ of other terminals relative to terminal 701 are within the set angle range [β₁, β₂], wherein the zero direction of the angle is the direction of movement of the terminal, −π/2≤β₁<β₂≤π/2. The angle range [β₁, β₂] can be preset by the terminal or determined based on information from other terminals, or relevant configuration can be obtained through at least one of the following: downlink control information, sidelink control information, physical downlink shared channel, physical downlink control channel, physical sidelink shared channel, physical sidelink control channel, high-layer signaling (e.g., RRC signaling, MAC signaling). Terminal 701 can transmit the message for collaborative sensing to terminals within a fixed distance and angle range only, which not only reduces the overhead and complexity of communication resources, but also ensures that the delay in transmitting message for collaborative sensing meets a certain low latency requirement. As another embodiment, when no terminals meeting the angle range requirements mentioned above are detected, the terminal 701 does not transmit the sensing collaboration message.

(4) The power of the time domain channel estimation results of echo signals from other terminals is greater than or equal to a power threshold Pₜₕ, wherein Pₜₕ can be referred to as a third threshold value, wherein Pₜₕ is a number greater than or equal to zero, and its typical value can be the power greater than the noise floor, wherein the noise floor can be a theoretical value or a measured value.

For example, terminal 701 can select a terminal corresponding to the highest power of the time domain channel estimation result based on the echo signal of the sensing signal and transmit a request message for requesting collaborative sensing to the terminal. Alternatively, terminal 701 can select terminals whose power of the time domain channel estimation result of the echo signal is greater than or equal to the third threshold value based on the echo signals of the sensing signal, and transmit a request message for requesting collaborative sensing. The third threshold value can be a value preset by terminal 701, or a value determined based on information from other terminals, or relevant configuration can be obtained through at least one of the following: downlink control information, sidelink control information, physical downlink shared channel, physical downlink control channel, physical sidelink shared channel, physical sidelink control channel, high-layer signaling (e.g., RRC signaling, MAC signaling). Terminal 701 can avoid the power of its echo signal being lower or lower than the power of the clutter due to lower reflection coefficients at other terminals or interference from clutter, which makes it impossible for terminal 701 to determine the actual distance of the terminal based on the time domain channel estimation results of the echo signal of the sensing signal. This method adopts unicast method, which can effectively reduce the overhead of the communication resource and complexity. Moreover, transmitting the request message for collaborative sensing to the terminal corresponding to the highest power of the echo signal of the sensing signal or to terminals whose power of the time domain channel estimation result of the echo signal of the sensing signal meets the third threshold value can effectively reduce the delay caused by message propagation and improve the validity of the message. As another embodiment, when no other terminals are detected by the terminal, or when the power of the time domain channel estimation results of the echo signals of the sensing signals of all detected terminals is less than the third threshold value, the terminal 701 does not transmit the message for collaborative sensing.

(5) The power of the Doppler domain channel estimation results of the echo signals from other terminals is greater than or equal to a power threshold pdₜₕ, wherein pdₜₕ can be referred to as a fourth threshold value, wherein pdₜₕ is a number greater than or equal to zero, and its typical value can be the power greater than the noise floor, wherein the noise floor can be a theoretical value or a measured value. For example, terminal 701 can select a terminal corresponding to the highest power of the Doppler domain channel estimation result based on the echo signal of the sensing signal and transmit the request message for requesting collaborative sensing to the terminal. Alternatively, terminal 701 can select terminals whose power of the Doppler domain channel estimation result of the echo signal is greater than or equal to the fourth threshold value based on the echo signal of the sensing signal and transmit the request message for requesting collaborative sensing. The fourth threshold value can be a value preset by terminal 701, or can be a value determined based on information from other terminals, or relevant configuration can be obtained through at least one of the following: downlink control information, sidelink control information, physical downlink shared channel, physical downlink control channel, physical sidelink shared channel, physical sidelink control channel, high-layer signaling (e.g., RRC signaling, MAC signaling). Terminal 701 can solve the problem of difficulty in distinguishing between stationary targets and clutter, and effectively reduce the impact of clutter on detection performance by detecting moving targets. Transmitting the request message for requesting collaborative sensing to the terminal corresponding to the highest power of the echo signal of the sensing signal or to terminals whose power of the Doppler domain channel estimation result of the echo signal of the sensing signal meets the fourth threshold value can effectively reduce the delay caused by message propagation and improve the effectiveness of the message. As another embodiment, when no other terminals are detected by the terminal, or when the power of the Doppler domain channel estimation results of the echo signals from all detected terminal is less than the fourth threshold value, the terminal 701 does not transmit the message for collaborative sensing.

(6) The number of other terminals sensed by terminal 701 is greater than zero and less than or equal to a first number. Alternatively, when the number of terminals sensed by terminal 701 during beam scanning is greater than the first number, terminal 701 can further select other suitable terminals based on the distance and angles of other terminals relative to terminal 701 and/or the channel estimation result of the echo signal of the sensing signal mentioned above, and transmit a request message for requesting collaborative sensing to the terminals. The specific method can be seen above and will not be repeated here. The first number is an integer greater than or equal to zero, which can be a value preset by terminal 701, or can be a value determined based on information from other terminals, or relevant configuration can be obtained through at least one of the following: downlink control information, sidelink control information, physical downlink shared channel, physical downlink control channel, physical sidelink shared channel, physical sidelink control channel, high-layer signaling (e.g., RRC signaling, MAC signaling). Terminal 701 can flexibly adjust the way of transmitting message for collaborative sensing based on the number of sensed terminals, achieving a balance between performance, resource overhead, latency requirements, and complexity. As another embodiment, when no other terminals are detected by the terminal, the terminal 701 does not transmit the message for collaborative sensing.

(7) The position of other terminals relative to terminal 701 remains unchanged or the amount of position change is less than or equal to a fourth threshold within a second time range. For example, terminal 701 can obtain sensing information such as distance, angle, velocity, and direction of movement of multiple sets of other terminals relative to terminal 701 through multiple rounds of beam scanning. Terminal 701 can determine the position information, such as latitude and longitude, of other terminals relative to terminal 701 based on the sensing information. Terminal 701 can select terminals whose position remains unchanged or the amount of position change is less than or equal to the fourth threshold within the second time range, and transmit the message for collaborative sensing. The second time range and fourth threshold can be a value preset by terminal 701, or can be a value determined based on information from other terminals, or relevant configuration can be obtained through at least one of the following: downlink control information, sidelink control information, physical downlink shared channel, physical downlink control channel, physical sidelink shared channel, physical sidelink control channel, high-layer signaling (e.g., RRC signaling, MAC signaling). The terminal with small or no changes in position can reduce the decrease in reliability of the sensing information shared with terminal 701 caused by significant changes in position. As another embodiment, when no terminals meeting the specified position condition are detected, terminal 701 does not transmit the message for collaborative sensing. Furthermore, after selecting other terminals that meet the condition based on the location information of other terminals, terminal 701 can further select other suitable terminals based on the distance and angles of other terminals relative to terminal 701 and/or the channel estimation result of the echo signal of the sensing signal mentioned above, and transmit a request message for requesting collaborative sensing to the terminals. The specific method can be seen above, and will not be repeated here.

(8) The number of other terminals sensed by terminal 701 based on different beam sets can be greater than zero and less than or equal to a second number. Specifically, terminal 701 can perform beam scanning using multiple groups of different beam sets to obtain sensing results of multiple groups of other terminals. For example, terminal 701 can perform scanning based on two different groups of beam sets, wherein the first beam set is a beam set characterized by a higher side lobe suppression (high peak side lobe ratio) and a lower angular resolution; the second beam set is a beam set characterized by a lower side lobe suppression (low peak side lobe ratio) and a higher angular resolution. When using the first beam set for scanning, terminal 701 can effectively suppress the impact of side lobe clutter or other interference on sensing performance at the expense of a certain degree of angle resolution, and detect the accurate distance and/or velocity of other terminals; when using the second beam set for scanning, terminal 701 can detect the accurate angle of other terminals. Terminal 701 can select terminals that can be determined from the sensing results of the first and second beam sets, and transmit a message for collaborative sensing to the terminals. In addition, terminal 701 can also select other terminals that meet the condition according to the position information or the number of other terminals based on the scanning results of different beam sets, and then transmit a message for collaborative sensing. The specific method can be seen above, and will not be repeated here. Alternatively, terminal 701 can also select other terminals that meet the condition according to the position information or the number of other terminals based on the scanning results of different beam sets, and after that, terminal 701 can select further other suitable terminals based on the distance and angles of other terminals relative to terminal 701 and/or the channel estimation result of the echo signal of the sensing signal mentioned above, and transmit a message for collaborative sensing to the terminals. The specific method can be seen above, and will not be repeated here.

In some embodiments, in the case of the second condition mentioned above being met, terminal 701 can further determine the method of transmitting a request message for requesting collaborative sensing based on the sensing information.

In an example, in the case of the distance d of other terminals relative to terminal 701 being less than or equal to the third threshold, when only the distance of a single terminal relative to terminal 701 is less than or equal to the third threshold, terminal 701 can transmit a request message for requesting collaborative sensing to the terminal through unicast. Alternatively, when the distance of multiple terminals relative to terminal 701 is less than or equal to the third threshold, terminal 701 can transmit a request message for requesting collaborative sensing to the multiple terminals through unicast, multicast, or broadcast.

In an example, in the case of the angles θ of other terminals relative to terminal 701 being within the set angle range [β₁, β₂], when only the angle θ of a single terminal relative to terminal 701 is within the set angle range [β₁, β₂], terminal 701 can transmit a request message for requesting collaborative sensing to the terminal through unicast. Alternatively, when the angles θ of multiple terminals relative to terminal 701 are within the set angle range [β₁, β₂], terminal 701 can transmit a request message for requesting collaborative sensing to the multiple terminals through unicast, multicast, or broadcast.

In an example, in the case of the power of the time domain channel estimation results of the echo signals from other terminals being greater than or equal to the third threshold value, when only the power of the time domain channel estimation result of the echo signal from single terminal is greater than or equal to the third threshold value, terminal 701 can transmit a request message for requesting collaborative sensing to the terminal through unicast. Alternatively, when the power of the time domain channel estimation results of the echo signals from multiple terminals is greater than or equal to the third threshold value, terminal 701 can transmit a request message for requesting collaborative sensing to the multiple terminals through multicast or broadcast.

In an example, in the case of the power of the Doppler domain channel estimation results of the echo signals from other terminals being greater than or equal to the fourth threshold value, when only the power of the Doppler domain channel estimation result of the echo signal from single terminal is greater than or equal to the fourth threshold value, terminal 701 can transmit a request message for requesting collaborative sensing to the terminal through unicast. Alternatively, when the power of the Doppler domain channel estimation results of echo signals from multiple terminals is greater than or equal to the fourth threshold value, terminal 701 can transmit a request message for requesting collaborative sensing to the multiple terminals through multicast or broadcast.

In an example, in the case of the number of other terminals sensed by terminal 701 being greater than zero and less than or equal to the first number, when the number of other terminals sensed by terminal 701 is only one, terminal 701 can transmit a request message for requesting collaborative sensing to the terminal through unicast. Alternatively, when the number of other terminals sensed by terminal 701 is greater than 1, terminal 701 can transmit a request message for requesting collaborative sensing to the multiple terminals through unicast, multicast, or broadcast.

In an example, in the case of the position of other terminals relative to terminal 701 remains unchanged or the amount of position change is less than or equal to the fourth threshold within the second time range, when the number of terminals whose position relative to terminal 701 remains unchanged or the amount of position change is less than or equal to the fourth threshold within the second time range is only one, terminal 701 can transmit a request message for requesting collaborative sensing to the terminal through unicast. Alternatively, when the number of terminals whose position relative to terminal 701 remains unchanged or the amount of position change is less than or equal to the fourth threshold within the second time range is greater than 1, terminal 701 can transmit a request message for requesting collaborative sensing to the multiple terminals through unicast, multicast, or broadcast.

In an example, in the case of the number of other terminals sensed by terminal 701 based on different beam sets is greater than zero and less than or equal to the second number, when the number of other terminals sensed is only one, terminal 701 can transmit a request message for requesting collaborative sensing to the terminal through unicast. Alternatively, when the number of other terminals sensed is greater than 1, terminal 701 can transmit a request message for requesting collaborative sensing to the multiple terminals through unicast, multicast, or broadcast. It should be noted that in the example, terminal 701 performs sensing based on the first and second beam sets, but the number of beam sets that terminal 701 can use for sensing is not limited to two, and can be more than two. In the case that more than two beam sets are used, the terminal can select terminals based on the sensing results of multiple beam sets to transmit a request message for requesting collaborative sensing, such as selecting other terminals that are sensed jointly based on multiple beam sets.

S715: When the conditions for transmitting the request message for collaborative sensing described in S710 are not met, terminal 701 does not transmit the request message for collaborative sensing.

S720: When the conditions for transmitting the request message for collaborative sensing described in S710 are met, terminal 701 generates the request message for collaborative sensing to request other terminals around the terminal (such as terminal 702 in FIG. 7) to sense collaboratively.

The request message can include at least one of the following: sensing accuracy parameters, occupancy information of resources for sensing, position information of the terminal, velocity information of the terminal, range for collaborative sensing, wherein the range for collaborative sensing can also be referred to as a first range.

Wherein the sensing accuracy related parameters are used to reflect the terminal's requirements for sensing accuracy. The sensing accuracy parameters can also be replaced by other names, and the present disclosure does not limit its naming. For example, the sensing accuracy parameters includes at least one of the following: distance sensing accuracy parameter, velocity sensing accuracy parameter, and angle sensing accuracy parameter. The distance sensing accuracy parameter can also be referred to as the sensing accuracy parameter for distance, the velocity sensing accuracy parameter can also be referred to as the sensing accuracy parameter for velocity, and the angle sensing accuracy parameter can also be referred to as the sensing accuracy parameter for angle, and the present disclosure does not limit their naming. The sensing resource occupation information is used to indicate the occupation of time-frequency resources of radio frames used by terminal 701 for beam scanning. The position information of the terminal is the position information of terminal 701. For example, position information can be the longitude and latitude information of the position where terminal 701 is located. For example, terminal 701 can obtain its current position information through technologies such as GPS positioning or cellular positioning, and the position information can be the longitude and latitude of terminal 701. The velocity information of the terminal includes the magnitude and/or direction of the velocity of the terminal. The range for collaborative sensing is the angle range and/or distance range that the terminal 701 requests other terminals to sense collaboratively.

In this embodiment, the terminal has different sensing accuracy requirements for different scenarios. For example, when the terminal senses targets that may collide in close range, there will be a requirement of higher sensing accuracy. However, when the terminal senses targets in remote distance, there will be a requirement of lower sensing accuracy. For example, in the scenario where the terminal moves in high velocity, there will be a requirement of higher sensing accuracy, while in scenario where the terminal moves in medium to low velocity, there will be a requirement of lower sensing accuracy. For another example, when the terminal is moving within a city, due to the high density of targets in the surrounding environment, there will be a requirement of higher sensing accuracy; when the terminal moves in the field environment, due to the low density of targets in the surrounding environment, there will be a requirement of lower sensing accuracy. The terminal can transmit sensing accuracy parameters related to sensing accuracy requirements to other terminals through the request message for requesting collaborative sensing. Transmitting sensing accuracy parameters can improve the reliability of receiving sensing information from other terminals while meeting the sensing accuracy requirements.

In one possible implementation, different sensing parameters are defined with the minimum sensing accuracy unit, for example, the minimum sensing accuracy unit for distance is Δd, the minimum sensing accuracy unit for velocity is Δv, and the minimum sensing accuracy unit for angle is Δθ. Based on the minimum sensing accuracy unit, different sensing accuracy of the terminal can be quantified into different levels. Table 2 shows an example of distance sensing accuracy quantization, wherein distance sensing accuracy is quantified into N levels, N is an integer greater than or equal to zero, αᵢ<αᵢ, i=1, . . . , N−1, wherein αᵢ is a positive number, and typical values can be taken as αᵢ=i, i=1, . . . , N. It should be noted that velocity and angle can be quantified into multiple levels of sensing accuracy in a manner similar to Table 2, which will not be repeated here. Quantifying sensing accuracy into levels and transmitting the sensing accuracy to other terminals through collaborative request message can occupy less overhead and reduce latency.

TABLE 2

| level | distance sensing accuracy |
|---|---|
| 1 | α₁ · Δd |
| 2 | α₂ · Δd |
| 3 | α₃ · Δd |
| . . . | . . . |
| N | α_{N} · Δd |

In this embodiment, terminal 701 can obtain its current position through technologies such as GPS positioning or cellular positioning. Terminal 701 can also obtain position assistance information through interaction with adjacent terminals, and then integrate its own positioning results and position assistance information obtained from adjacent terminals to perform positioning. For example, the wireless communication technology used in terminal communication can be cellular communication technology, WiFi technology, Bluetooth technology, C-V2X or DSRC technology, etc.

In this embodiment, the request message for requesting collaborative sensing transmitted by terminal 701 may include occupancy information of resources for sensing, which refers to the occupancy information of the time-frequency resource of radio frame used by the terminal for beam scanning. For example, the time-frequency resource of the radio frame can be configured from at least one of the following nodes: base station, terminal, road side unit, and can be configured statically, semi-statically, or dynamically. Alternatively, terminal 701 can preempt resources already occupied by other terminals for sensing based on the priority of the sensing task, and inform other terminals of information of the preempted resource through the occupancy information of resources for sensing in the request message for requesting collaborative sensing. This avoids the surrounding terminals from selecting resources that have already been occupied for sensing, and prevents the degradation of sensing performance caused by resource conflicts.

In this embodiment, the request message for requesting collaborative sensing transmitted by terminal 701 may also include a range for collaborative sensing, which is the angle range and/or distance range that terminal 701 requests other terminals to sense collaboratively. Terminal 701 can determine the range for collaborative sensing based on its own sensing results. For example, the range for collaborative sensing can be the blind spot range in sensing of terminal 701, terminal 701 transmits information related to the blind spot range to other terminals to request collaborative sensing. For terminals that can sense within the range for collaborative sensing, the sensing results of targets within the range can be transmitted to terminal 701, terminal 701 can determine whether targets exist within the range for collaborative sensing based on the received sensing results. It should be noted that the blind spot range in sensing can be caused by the limited sensing angle of the terminal's radar sensor, or it can be caused by the obstruction of other objects. For the situation where the sensing blind spot is caused by the obstruction of other objects, the terminal can determine its blind spot range in sensing, such as the angle range, based on the sensing information of the obstructing object. In addition, the range for collaborative sensing is not limited to the blind spot range of the terminal, but can also be the range at the edge of the terminal's sensing range. Through feedback of sensing information from other terminals, terminal 701 can obtain the sensing information at the edge of its own sensing range. S720: Terminal 701 transmits the request message for requesting collaborative sensing to other surrounding terminals, such as terminal 702 shown the figure, causing adjacent terminals to feedback a response message for collaborative sensing based on the request message for requesting collaborative sensing. For example, terminal 701 can transmit the request message for requesting collaborative sensing through V2X communication. Terminal 701 transmits the request message for requesting collaborative sensing to adjacent terminals through at least one of the following: broadcast, multicast, or unicast. When terminal 701 transmits the request message for requesting collaborative sensing through broadcasting or multicasting, terminal 701 can receive multiple response messages for collaborative sensing feedback from other terminals, the multiple response messages for collaborative sensing can provide more sensing information about targets within the blind spot of the terminal, facilitating the terminal to adjust to the beam scanning suitable for the current situation.

S730: Terminal 702 receives the request message for requesting collaborative sensing transmitted by terminal 701. For example, terminal 702 can receive the request message for requesting collaborative sensing through V2X communication.

S740: Terminal 702 determines whether to transmit a response message for collaborative sensing based on the received request message for requesting collaborative sensing. If the condition is met, proceeds to S742. If the condition is not met, proceeds to S741. For example, terminal 702 can obtain at least one of the following based on the request message for requesting collaborative sensing: sensing accuracy parameters, occupancy information of resource used by terminal 701 for sensing, position information of terminal 701, velocity information of terminal 701, and range for collaborative sensing of terminal 701.

In some embodiments, the condition for the terminal 702 transmitting the response message for collaborative sensing can include at least one of the following:
The sensing accuracy of terminal 702 meets the sensing accuracy parameter requirement in the request message for collaborative sensing;
There is no conflict between the time-frequency resources of the radio frames used by terminal 702 for sensing and/or communication and the time-frequency resources of the radio frames used by terminal 701 for sensing and/or communication;
Terminal 701 is located within the communication and/or sensing range of terminal 702;
The range for collaborative sensing transmitted by terminal 701 is within the sensing range of terminal 702;
The range for collaborative sensing transmitted by terminal 701 is within the sensing range of terminal 702, and terminal 702 has sensed a target within the range for collaborative sensing.

In addition, when the position of terminal 701 relative to terminal 702 changes, the range for collaborative sensing required by terminal 701 may vary. Terminal 701 can also determine the beam scanning range dynamically based on the latest sensing information obtained by beam scanning.

One possible implementation is that terminal 702 obtains the sensing collaborative range in the request message for requesting collaborative sensing from terminal 701. The method for terminal 702 determining whether the range for collaborative sensing relative to terminal 701 is within its own sensing range can be determining whether its beam scanning range covers the range for collaborative sensing based on the position information of terminal 701. When terminal 702 determines that the range for collaborative sensing relative to terminal 701 is within its own sensing range, terminal 702 senses within the range for collaborative sensing and feeds back the sensed sensing information to terminal 701 through the response message for collaborative sensing. For example, the condition for terminal 702 sensing the target within the range for collaborative sensing can be at least one of the following: the power of the time domain channel estimation result of the echo signal of the sensing signal transmitted by terminal 702 is greater than or equal to a fifth threshold value, and the power of the Doppler domain channel estimation result of the echo signal of the sensing signal transmitted by terminal 702 is greater than or equal to a sixth threshold value. The sensing signal transmitted by terminal 702 can be referred to as a fourth signal. The fifth and sixth threshold values can be set by terminal 702 according to the actual situation. For example, both the fifth and sixth threshold value are power greater than the noise floor, wherein the noise floor can be either a theoretical value or an estimated value.

S741: Terminal 702 does not respond to the request message for requesting collaborative sensing transmitted by terminal 701.

S750: Terminal 702 transmits a response message for collaborative sensing to terminal 701.

For example, terminal 702 generates a response message for collaborative sensing, wherein the response message for collaborative sensing includes at least one of the following: position information of terminal 702, velocity information of terminal 702, sensing information of targets sensed by terminal 702 within the range for collaborative sensing transmitted by terminal 701, position information of targets sensed by terminal 702 within the range for collaborative sensing transmitted by terminal 701, and occupancy information of resources used by terminal 702 for sensing.

Wherein the position information of terminal 702 can be the longitude and latitude of terminal 702, and terminal 702 can obtain its current position information through technologies such as GPS positioning or cellular positioning. For example, the velocity information of terminal 702 includes the magnitude and direction of the velocity of terminal 702. The sensing information of the targets includes at least one of the following: the distance, angle, velocity, and direction of movement of the targets relative to the terminal 702. The position information of the targets sensed by terminal 702 within the range for collaborative sensing transmitted by terminal 701 can be the position information of the targets determined by terminal 702 based on the sensing information, the position information can be the longitude and latitude of the targets. The occupation information of resources used by terminal 702 for sensing refers to the occupation information of the time-frequency resources of the radio frames used by terminal 702 for beam scanning.

S760: Terminal 701 receives a response message for collaborative sensing from other terminals, such as terminal 702.

In this embodiment, terminal 701 may receive multiple communication beams, transmitted by other terminals surrounding terminal 701 at different times. The beams carrying response messages for collaborative sensing are used to transmit the response messages for collaborative sensing. In this case, terminal 701 can use any one of the received multiple beams as the first beam, or use the beam with the best signal quality among the received multiple beams as the first beam. Alternatively, the beam with a quality greater than or equal to a certain threshold among the received multiple beams can be used as the first beam set. The criteria for determining the quality of the beam signal can be at least one of the following measurements: Reference Signal Receiving Power (RSRP) of the beam, Reference Signal Receiving Quality (RSRQ) of the beam, signal-to-noise ratio of the beam, or a comprehensive estimation value calculated based on several parameters of the above estimation values. In this embodiment, the larger the estimated value, the better the quality of the beam.

It should be noted that in this embodiment, a single terminal 702 for collaborative sensing is used as an example, but there may be multiple terminals surrounding terminal 701 that are used for collaborative sensing. When there are multiple terminals for collaborative sensing, there may be multiple messages for collaborative sensing received by terminal 701. In addition, terminal 701 can also serve as a terminal for collaborative sensing, receiving request message for requesting collaborative sensing transmitted by other terminals and providing response messages for collaborative sensing as feedback. In this embodiment, terminal 701 and terminal 702 can be mutually interchangeable.

S770: Terminal 701 adjusts sensing related (beam scanning) parameters based on response messages for collaborative sensing, and transmits a sensing signal based on the adjusted sensing parameters, wherein the sensing signal can be referred to as a second signal.

For example, terminal 701 obtains response message for collaborative sensing carried in the first beam, or terminal 701 obtains multiple response messages for collaborative sensing carried in the first beam set. Terminal 701 can determine beam scanning parameters based on the single or the multiple response messages for collaborative sensing. The beam scanning parameters include at least one of the following parameters: beam scanning mode, single or multiple beam scanning ranges, wherein each beam scanning range can also be configured with beam scanning period, beam scanning interval, beam type, angle of main lobe beam, power of main lobe beam, peak side lobe ratio, and beam set.

Alternatively, one possible implementation for terminal 701 to determine beam scanning parameters is that terminal 701 can determine beam scanning parameters based on the sensing results of the targets the within the range for collaborative sensing sensed by single or multiple terminals. Terminal 701 determines at least one of the following parameters of the target in the blind spot range relative to terminal 701 based on the collaborative sensing results sensed by single or multiple other terminals: distance, angle, velocity, and direction of movement. For example, terminal 701 determines the distance of target relative to itself in the blind spot range, and uses a larger beam scanning range when the distance of target is less than or equal to dₜₕ, while uses a smaller beam scanning range when the distance of target is greater than or equal to dt. It should be noted that when the position of the target relative to terminal 701 changes, the terminal 701 can also determine the beam scanning range dynamically based on messages for collaborative sensing. Alternatively, terminal 701 determines the angle of the target in the blind spot range relative to itself, terminal 701 can determine beam scanning parameters based on its distance relative to the blind spot and the angle information of the target in the blind spot range relative to itself. Alternatively, terminal 701 determines the angle and distance of the target relative to itself in the blind spot range, and the terminal can determine the position of the target in the blind spot range, and thereby determine the beam scanning parameters based on the determined position of the target in the blind spot range.

Alternatively, another possible implementation for terminal 701 to determine beam scanning parameters is that terminal 701 can determine beam scanning parameters based on the position information of target within the range for collaborative sensing determined by single or multiple terminals, wherein the position information of the target can be the longitude and latitude of the target. For multiple sets of longitude and latitude of target determined by multiple terminals, terminal 701 can calculate the average value of multiple sets of longitude and latitude to determine the longitude and latitude of the target.

Alternatively, terminal 701 can select to use different beam scanning periods (frequencies) for different beam scanning ranges. For example, terminal can use lower beam scanning frequency, i.e. longer beam scanning period, for non-blind spot or range for non-collaborative sensing, while terminal can increase the beam scanning frequency, i.e. shorten beam scanning period, for the blind spot or the range for collaborative sensing. The blind spot range may also vary according to the different sensing angle range of the terminal. The blind spot range will be smaller when the sensing angle range of the terminal is larger, whereas the blind spot range will be larger when the sensing angle range of the terminal is smaller. When the sensing angle range of the terminal is larger, the corresponding sensing delay will be higher. Therefore, when the terminal determines the potential blind spot range, it can expand the scanning range for the blind spot range and/or increase the beam scanning frequency, thereby reducing the blind spot range, reducing the sensing delay in the blind spot range, and improving the sensing accuracy in the blind spot range.

Alternatively, the terminal can use either a non-adaptive or adaptive method for selecting beams from the beam set for beam scanning. In the non-adaptive method, scanning can be performed at a fixed angle interval, with a fixed angle interval of main lobes being 3 dB beamwidth. Alternatively, scanning can be performed at a non-fixed angle interval. For example, a wide beam with a larger angle interval can be initially used for coarse scanning, and then a narrow beam with a smaller angle interval can be used for fine scanning within the angle range where the target(s) exists. The adaptive method can, based on the sensing information obtained by processing and analyzing echo signal, select appropriate beam scanning parameters or beam set adaptively for beam scanning to sense.

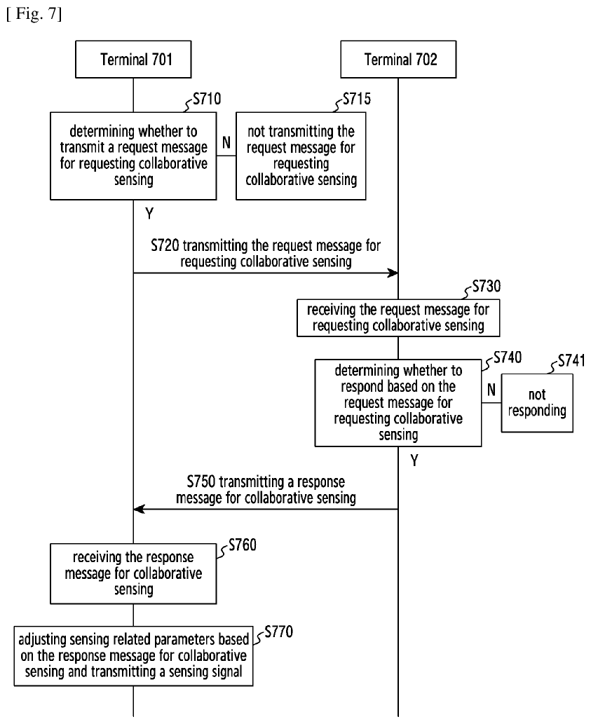

FIG. 8 illustrates a flowchart of another method for adjusting beam scanning parameters through collaborative sensing between terminals.

As shown in FIG. 8, FIG. 8 illustrates a flowchart of a collaborative sensing method between terminals according to the disclosed embodiment. This embodiment is a further supplementary description based on the method in FIG. 7, which specifically includes the following steps:

S810: Terminal 801 determines whether to transmit a request message for requesting collaborative sensing. If the condition is met, proceeds to S820; If the condition is not met, proceeds to S815.

Specifically, the implementation of S810 refers to S710 in FIG. 7.

S815: If terminal 801 does not meet the condition for transmitting the request message for requesting collaborative sensing described in S810, terminal 801 does not transmit the request message for requesting collaborative sensing.

S820: Terminal 801 meets the condition for transmitting the request message for requesting collaborative sensing described in S810, and terminal 801 generates the request message for requesting collaborative sensing to request other terminals surrounding the terminal (such as terminal 702 in FIG. 7) to sense collaboratively. Specifically, the implementation of S820 refers to S720 in FIG. 7.

S825: Terminal 801 starts a timer after transmitting the request message for requesting collaborative sensing to determine whether the delay in receiving a response message for collaborative sensing is greater than or equal to a specified delay threshold. The specific description regarding the delay threshold is provided in S861.

The implementation of S830, S840, S841, and S850 can be referred to S730, S740, S741, and S750 in FIG. 7, without further description.

S860: Terminal 801 receives the response message for collaborative sensing from other terminals, such as terminal 802.

Specifically, the implementation of S860 refers to S760 in FIG. 7.

S861: Terminal 801 determines whether the delay is greater than or equal to the delay threshold, the delay threshold can be referred to as a first delay threshold. Terminal 801 determines whether the delay in receiving the response message for collaborative sensing is greater than or equal to the delay threshold. When the delay is greater than or equal to the delay threshold, terminal 801 proceeds to S862, while when the delay is less than the delay threshold, terminal 801 proceeds to S870.

In this embodiment, one possible implementation to determine whether the delay is greater than or equal to the delay threshold includes: the terminal generates the request message for requesting collaborative sensing, and transmits the generated request message for requesting collaborative sensing to surrounding terminals using at least one of the following: broadcast, multicast, unicast. After terminal 801 transmits the request message for requesting collaborative sensing, if no response message for collaborative sensing transmitted by other terminals is received within the delay threshold T, terminal 801 proceeds to S862; alternatively, if the delay of the response message for collaborative sensing received by terminal 801 from other terminals is greater than or equal to the delay threshold T, terminal 801 proceeds to S862, and determines that the response message for collaborative sensing with delay greater than or equal to the delay threshold is invalid. When the delay in receiving the response message for collaborative sensing by terminal 801 from other terminals is less than the delay threshold T, terminal 801 proceeds to S870. The delay threshold T can be a value preset by terminal 701, or can be a value determined based on information from other terminals, or relevant configuration can be obtained through at least one of the following channels: downlink control information, sidelink control information, physical downlink shared channel, physical downlink control channel, physical sidelink shared channel, physical sidelink control channel, high-layer signaling (e.g., RRC signaling, MAC signaling, etc.). By determining whether the delay is greater than or equal to the delay threshold, terminal 801 can improve the reliability of the received response message for collaborative sensing and reduce errors introduced due to the low timeliness of sensing information from other terminal.

S862: Terminal 801 determines that the received response message for collaborative sensing is invalid.

S870: Terminal 801 adjusts sensing related (beam scanning) parameters based on the response message for collaborative sensing, and transmits a sensing signal based on the adjusted sensing parameters.

The specific implementation of this step can refer to S770 in FIG. 7.

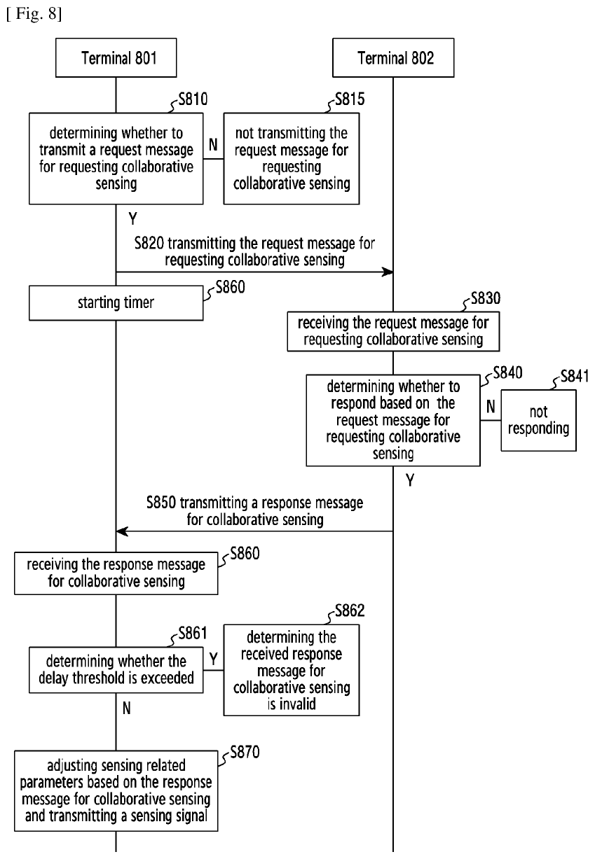

FIG. 9 illustrates a flowchart of yet another method for adjusting beam scanning parameters through collaborative sensing between terminals.

As shown in FIG. 9, FIG. 9 illustrates a flowchart of a collaborative sensing method between terminals according to the disclosed embodiment. This embodiment is a further supplementary description based on the method in FIG. 7, which specifically includes the following steps:

S910~S960 can refer to S710~S760 in FIG. 7.

S961: Terminal 901 determines whether the received message for collaborative sensing is valid. When the collaborative terminal 902 is far away from terminal 901 or at a high velocity, the sensing information of targets sensed by terminal 902 within the blind spot range or the sensing collaborative range may have significant errors and cannot be utilized by terminal 901. Therefore, terminal 901 needs to determine whether the received message for collaborative sensing is valid. If the message is valid, proceeds to S970, and if the message is invalid, proceeds to S962.

In this embodiment, one possible implementation to determine whether a message for collaborative sensing is valid includes: terminal 901 configures a safe radius distance threshold, based on the sensing information of terminal 902, terminal 901 determines that the distance of target relative to terminal 902 within the blind spot range or the range for collaboration is greater than or equal to the safe radius distance threshold, then the message for collaborative sensing is considered as invalid, wherein the safe radius distance threshold can be a value preset by terminal 901 based on its own hardware performance. The better the performance, the smaller the safe radius distance threshold; the worse the performance, the larger the safe radius distance threshold, and the safe radius distance threshold can be referred to as a second range.

Alternatively, terminal 901 can also report its sensing ability to the base station or other nodes. Terminal 901 obtains relevant configuration through at least one of the following: downlink control information, sidelink control information, physical downlink shared channel, physical downlink control channel, physical sidelink shared channel, physical sidelink control channel, high-layer signaling (e.g., RRC signaling, MAC signaling), from at least one node of the base station, other terminals, and Road Side Unit.

S962: Terminal 901 determines that the received response message for collaborative sensing is invalid.

S970: Terminal 901 adjusts sensing related (beam scanning) parameters based on the response message for collaborative sensing, and transmits a sensing signal based on the adjusted sensing parameters.

The specific implementation of this step can refer to S770 in FIG. 7.

According to the disclosed embodiment, an electronic device can also be provided, including: at least one processor; and at least one memory storing computer executable instructions, wherein when executed by the at least one processor, the computer executable instructions cause the at least one processor to perform any one of the methods described above.

FIG. 10 illustrates a block diagram of an example of a base station according to the disclosed embodiment.

As shown in FIG. 10, the base station according to an embodiment may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip. Also, the processor 1030 may include at least one processor. Furthermore, the base station of FIG. 10 corresponds to the gNB 102 of the FIG. 2.

The transceiver 1010 collectively refers to a base station receiver and a base station transmitter, and may transmit/receive a signal to/from a terminal (UE) or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as read-only memory (ROM), random access memory (RAM), a hard disk, a CD-ROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

FIG. 11 illustrates a block diagram of a terminal according to the disclosed embodiment.

As shown in FIG. 11, the terminal according to an embodiment may include a transceiver 1110, a memory 1120, and a processor 1130. The transceiver 1110, the memory 1120, and the processor 1130 of the terminal may operate according to a communication method of the terminal described above. However, the components of the terminal are not limited thereto. For example, the terminal may include more or fewer components than those described above. In addition, the processor 1130, the transceiver 1110, and the memory 1120 may be implemented as a single chip. Also, the processor 1130 may include at least one processor. Furthermore, the terminal of FIG. 11 corresponds to the UE 116 of the FIG. 3.

The transceiver 1110 collectively refers to a terminal receiver and a terminal transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the terminal. Also, the memory 1120 may store control information or data included in a signal obtained by the terminal. The memory 1120 may be a storage medium, such as read-only memory (ROM), random access memory (RAM), a hard disk, a CD-ROM, and a DVD, or a combination of storage media.

The processor 1130 may control a series of processes such that the terminal operates as described above. For example, the transceiver 1110 may receive a data signal including a control signal transmitted by the base station or the network entity, and the processor 1130 may determine a result of receiving the control signal and the data signal transmitted by the base station or the network entity.

In addition, it should be explained that although the terminal is described as units performing respective process, those skilled in the art would understand that the division of terminal units is not limited to the example shown in FIG. 10, as long as it is capable of performing the method disclosed in the disclosed embodiments.

As an example, electronic device can be PC computer, tablet device, personal digital assistant, smartphone, or other devices capable of executing the aforementioned set of instructions. Here, electronic device does not have to be individual electronic device, but can also be a combination of devices or circuits that can execute the above instructions (or instruction sets) individually or jointly. Electronic device can also be part of an integrated control system or system manager, or can be configured as portable electronic devices that interface with local or remote (for example, via wireless transmission).

In electronic devices, processors can include central processing units (CPU), graphics processor (GPU), programmable logic device, specialized processor system, microcontroller, or microprocessor. As an example, rather than a limitation, processor may also include analog processor, digital processor, microprocessor, multi-core processor, processor array, network processor, etc.

The processor can run instructions or code stored in memory, wherein the memory can also store data. Instructions and data can also be transmitted and received via a network through a network interface device, wherein the network interface device can adopt any known transmission protocol.

The memory can be integrated with the processor, for example, by arranging RAM or flash memory within the integrated circuit microprocessor, etc. In addition, the memory may include independent devices, such as external disk drive, storage array, or other storage device that can be used by any database system. The memory and processor can be coupled operationally, or they can communicate with each other, such as through I/O interfaces, network connections, etc., allowing the processor to read files stored in the memory.

Furthermore, electronic devices may also include video displays (such as LCD displays) and user interaction interfaces (such as keyboards, mice, touch input devices, etc.). All components of the electronic devices can be connected to each other via buses and/or networks.

According to the embodiments of the present disclosure, a computer-readable storage medium can be provided to store instructions, wherein when the instructions are executed by at least one processor, the at least one processor performs any of the methods disclosed in the exemplary embodiments of the present disclosure. Examples of computer-readable storage medium herein include: read-only memory (ROM), random access programmable read-only memory (PROM), electrically erasable programmable read-only memory (EEPROM), random-access memory (RAM), dynamic random-access memory (DRAM), static random-access memory (SRAM), flash memory, non-volatile memory, CD-ROM, CD-R, CD+R, CD-RW, CD+RW, DVD-ROM, DVD-R, DVD+R, DVD-RW DVD+RW, DVD-RAM, BD-ROM, BD-R, BD-R LTH, BD-RE, Blue-ray or optical disk storage, hard disk drive (HDD), solid-state drive (SSD), card storage (such as multimedia card, security digital (SD) card or extreme digital (XD) card), magnetic tape, floppy disk, magneto-optical data storage device, optical data storage device, hard disk, solid state disk and any other device capable of storing computer programs and any associated data, data files, and data structures in a non-transitory manner and providing the computer programs and any associated data, data files, and data structures to a processor or a computer to enable the execution of the computer programs. The instructions or computer programs in the above-mentioned computer-readable storage medium can run in environments deployed in computer devices such as clients, hosts, proxy devices, servers, etc. Furthermore, in one example, the computer programs and any associated data, data files, and data structures are distributed on networked computer systems, such that the computer program and any associated data, data files and data structures are stored, accessed, and executed in a distributed manner through one or more processors or computers.

In one embodiment, a 1. A method performed by a first user equipment (UE) in a wireless communication system, the method comprising: transmitting, to a second UE, a request message for collaborative sensing; receiving, from the second UE, a response message including sensing measurements based on the request message; and transmitting, to the second UE, a sensing signal for a beam selection based on the sensing measurements, wherein the second UE is a UE which is identified as a UE with the collaborative sensing based on the request message.

In one embodiment, wherein the request message includes information for identifying the second UE, wherein the information includes at least one of a sensing accuracy parameter, occupancy information of resources for sensing, position information of the first UE, velocity information of the first UE, or a range for the collaborative sensing, and wherein the range for the collaborative sensing includes at least one of an angle range or distance range between the first UE and the second UE.

In one embodiment, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.

In one embodiment, wherein the transmitting of the request message is triggered based on at least one of angles of the first UE and the second UE, a power of time domain channel estimation results of echo signal from the second UE, a power of Doppler domain channel estimation results of the echo signal, or a position of the second UE, and
wherein the receiving of the response message is triggered based on at least one of a sensing accuracy of the second UE, duplicates of resources between the first UE and the second UE, a position of the first UE, whether a range for the collaborative sensing is in a sensing range of the second UE, or whether a target is sensed within the range for the collaborative sensing.

In one embodiment, a method performed by a second user equipment (UE) in a wireless communication system, the method comprising: receiving, from a first UE, a request message for collaborative sensing; identifying the second UE is a UE with the collaborative sensing based on the request message; transmitting, to the first UE, a response message including sensing measurements based on the request message; and receiving, from the first UE, a sensing signal for a beam selection based on the sensing measurements.

In one embodiment, wherein the request message includes information for identifying the second UE, wherein the information includes at least one of a sensing accuracy parameter, occupancy information of resources for sensing, position information of the first UE, velocity information of the first UE, or a range for the collaborative sensing, and wherein the range for the collaborative sensing includes at least one of an angle range or distance range between the first UE and the second UE.

In one embodiment, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.

In one embodiment, wherein the receiving of the request message is triggered based on at least one of angles of the first UE and the second UE, a power of time domain channel estimation results of echo signal from the second UE, a power of Doppler domain channel estimation results of the echo signal, or a position of the second UE, and wherein the transmitting of the response message is triggered based on at least one of a sensing accuracy of the second UE, duplicates of resources between the first UE and the second UE, a position of the first UE, whether a range for the collaborative sensing is in a sensing range of the second UE, or whether a target is sensed within the range for the collaborative sensing.

In one embodiment, a first user equipment (UE) in a wireless communication system, the first UE comprising: a transceiver; and at least one controller coupled with the transceiver and configured to: transmit, to a second UE, a request message for collaborative sensing, receive, from the second UE, a response message including sensing measurements based on the request message, and transmit, to the second UE, a sensing signal for a beam selection based on the sensing measurements, wherein the second UE is a UE which is identified as a UE with the collaborative sensing based on the request message.

In one embodiment, wherein the request message includes information for identifying the second UE, wherein the information includes at least one of a sensing accuracy parameter, occupancy information of resources for sensing, position information of the first UE, velocity information of the first UE, or a range for the collaborative sensing, and wherein the range for the collaborative sensing includes at least one of an angle range or distance range between the first UE and the second UE.

In one embodiment, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.

In one embodiment, wherein the transmitting of the request message is triggered based on at least one of angles of the first UE and the second UE, a power of time domain channel estimation results of echo signal from the second UE, a power of Doppler domain channel estimation results of the echo signal, or a position of the second UE, and wherein the receiving of the response message is triggered based on at least one of a sensing accuracy of the second UE, duplicates of resources between the first UE and the second UE, a position of the first UE, whether a range for the collaborative sensing is in a sensing range of the second UE, or whether a target is sensed within the range for the collaborative sensing.

In one embodiment, a second user equipment (UE) in a wireless communication system, the second UE comprising: a transceiver; and at least one controller coupled with the transceiver and configured to: receive, from a first UE, a request message for collaborative sensing, identify the second UE is a UE with the collaborative sensing based on the request message, transmit, to the first UE, a response message including sensing measurements based on the request message, and receive, from the first UE, a sensing signal for a beam selection based on the sensing measurements.

In one embodiment, wherein the request message includes information for identifying the second UE, wherein the information includes at least one of a sensing accuracy parameter, occupancy information of resources for sensing, position information of the first UE, velocity information of the first UE, or a range for the collaborative sensing, and wherein the range for the collaborative sensing includes at least one of an angle range or distance range between the first UE and the second UE.

In one embodiment, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a first user equipment (UE) in a wireless communication system, the method comprising:
transmitting, to a second UE, a request message for collaborative sensing;
receiving, from the second UE, a response message including sensing measurements based on the request message; and
transmitting, to the second UE, a sensing signal for a beam selection based on the sensing measurements,
wherein the second UE is a UE which is identified as a UE with the collaborative sensing based on the request message.

2. The method of claim 1, wherein the request message includes information for identifying the second UE,
wherein the information includes at least one of a sensing accuracy parameter, occupancy information of resources for sensing, position information of the first UE, velocity information of the first UE, or a range for the collaborative sensing, and
wherein the range for the collaborative sensing includes at least one of an angle range or distance range between the first UE and the second UE.

3. The method of claim 1, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.

4. The method of claim 1, wherein the transmitting of the request message is triggered based on at least one of angles of the first UE and the second UE, a power of time domain channel estimation results of echo signal from the second UE, a power of Doppler domain channel estimation results of the echo signal, or a position of the second UE, and
wherein the receiving of the response message is triggered based on at least one of a sensing accuracy of the second UE, duplicates of resources between the first UE and the second UE, a position of the first UE, whether a range for the collaborative sensing is in a sensing range of the second UE, or whether a target is sensed within the range for the collaborative sensing.

5. A method performed by a second user equipment (UE) in a wireless communication system, the method comprising:
receiving, from a first UE, a request message for collaborative sensing;
identifying the second UE is a UE with the collaborative sensing based on the request message;
transmitting, to the first UE, a response message including sensing measurements based on the request message; and
receiving, from the first UE, a sensing signal for a beam selection based on the sensing measurements.

6. The method of claim 5, wherein the request message includes information for identifying the second UE,
wherein the information includes at least one of a sensing accuracy parameter, occupancy information of resources for sensing, position information of the first UE, velocity information of the first UE, or a range for the collaborative sensing, and
wherein the range for the collaborative sensing includes at least one of an angle range or distance range between the first UE and the second UE.

7. The method of claim 5, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.

8. The method of claim 5, wherein the receiving of the request message is triggered based on at least one of angles of the first UE and the second UE, a power of time domain channel estimation results of echo signal from the second UE, a power of Doppler domain channel estimation results of the echo signal, or a position of the second UE, and wherein the transmitting of the response message is triggered based on at least one of a sensing accuracy of the second UE, duplicates of resources between the first UE and the second UE, a position of the first UE, whether a range for the collaborative sensing is in a sensing range of the second UE, or whether a target is sensed within the range for the collaborative sensing.

9. A first user equipment (UE) in a wireless communication system, the first UE comprising:
a transceiver; and
at least one controller coupled with the transceiver and configured to:
transmit, to a second UE, a request message for collaborative sensing, receive, from the second UE, a response message including sensing measurements based on the request message, and
transmit, to the second UE, a sensing signal for a beam selection based on the sensing measurements,
wherein the second UE is a UE which is identified as a UE with the collaborative sensing based on the request message.

10. The first UE of claim 9, wherein the request message includes information for identifying the second UE,
wherein the information includes at least one of a sensing accuracy parameter, occupancy information of resources for sensing, position information of the first UE, velocity information of the first UE, or a range for the collaborative sensing, and
wherein the range for the collaborative sensing includes at least one of an angle range or distance range between the first UE and the second UE.

11. The first UE of claim 9, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.

12. The first UE of claim 9, wherein the transmitting of the request message is triggered based on at least one of angles of the first UE and the second UE, a power of time domain channel estimation results of echo signal from the second UE, a power of Doppler domain channel estimation results of the echo signal, or a position of the second UE, and
wherein the receiving of the response message is triggered based on at least one of a sensing accuracy of the second UE, duplicates of resources between the first UE and the second UE, a position of the first UE, whether a range for the collaborative sensing is in a sensing range of the second UE, or whether a target is sensed within the range for the collaborative sensing.

13. A second user equipment (UE) in a wireless communication system, the second UE comprising:
a transceiver; and
at least one controller coupled with the transceiver and configured to:
receive, from a first UE, a request message for collaborative sensing, identify the second UE is a UE with the collaborative sensing based on the request message,
transmit, to the first UE, a response message including sensing measurements based on the request message, and
receive, from the first UE, a sensing signal for a beam selection based on the sensing measurements.

14. The second UE of claim 13, wherein the request message includes information for identifying the second UE,
wherein the information includes at least one of a sensing accuracy parameter, occupancy information of resources for sensing, position information of the first UE, velocity information of the first UE, or a range for the collaborative sensing, and
wherein the range for the collaborative sensing includes at least one of an angle range or distance range between the first UE and the second UE.

15. The second UE of claim 13, wherein the sensing measurements includes at least one of position information of the second UE, velocity information of the second UE, sensing information of at least one target sensed by the second UE within a range for the collaborative sensing, position information of the at least one target, or occupancy information of resources used by the second UE.
